(19) United States
(12) Patent Application Publication
(10) Pub. No.: US 2025/0158433 A1
(43) Pub. Date: May 15, 2025

(54) POWER SUPPLY DEVICE, CONTROL METHOD OF SUCH A DEVICE, AND A KIT COMPRISING SUCH A DEVICE, AND AT LEAST ONE ACCESSORY

(71) Applicant: STIGA S.P.A. IN BREVE ANCHE ST. S.P.A., Castelfranco Veneto (IT)

(72) Inventors: Federico Bonollo, Breganze (IT); Daniele Tolotto, Chiarano (IT); Dario Martone, Padova (IT); Marco Villanova, Sernaglia della Battaglia (IT)

(21) Appl. No.: 18/840,514

(22) PCT Filed: Feb. 24, 2023
(86) PCT No.: PCT/IB2023/051729

§ 371 Date: Aug. 22, 2024

(30) Foreign Application Priority Data
Feb. 25, 2022 (IT) 102022000003656
Feb. 25, 2022 (IT) 102022000003659

(51) Int. Cl. H02J 7/00

(52) U.S. Cl. CPC H02J 7/0045; H02J 7/0013

(57) ABSTRACT

The invention relates to a device (500) for the power supply of energy configured to be transportable and to electrically power at least one power user (101, 102). The device (500) comprises a casing (501) configured to contain a plurality of batteries (B1-B4) in at least one predefined position charging arrangement intended to allow a charging of the plurality of batteries (B1-B4), and a control unit (10) configured to control the charging of the plurality of batteries (B1-B4). In an embodiment, the device (500) further comprises a service power user (510) and a connector, the service power user (510) being configured to be powered by a battery (B1) and to provide a driving force to an accessory (512, 513, 514) removably connectable to the device (500), the connector being arranged at the service power user (510) and being configured to retain and release the accessory (512, 513, 514).

### TECHNICAL FIELD

The present disclosure relates to the field of electronics, and in particular relates to a power supply device.

The present disclosure in detail relates to a control method of the power supply of at least one power user.

### BACKGROUND ART

Attempts have been made over the years to supply certain tools or vehicles for various applications with batteries, in particular for agriculture or gardening. In addition, large tools, or even small vehicles (especially lawnmowers) for agricultural or gardening applications with electrical power supply have recently become widespread. In the early days, the poor of effectiveness of such tools or vehicles was observed, mainly due to the reduced charging capacity possessed by the batteries of the past. In fact, before the advent of batteries with Ni-Mh or Lithium technology, lead-acid or zinc-carbon batteries were used, whose efficiency was poor and/or whose size was very large in relation to capacity.

Consequently, such tools or vehicles often discharged early, and a large amount of batteries had to be replaced. However, in the past years, the batteries were often not rechargeable or easily and quickly lost the ability to be recharged to the original (or nominal) charge value. Therefore, with the passage of time, the overall efficiency given by the use of batteries degraded little by little until reaching a level where the use of such tools or vehicles became almost inconvenient with respect to the use of alternatives to endothermic engines or manual operation. In fact, the life of the batteries and their charging capacity were both too limited for battery power to be a practical alternative to powering accessories requiring significant power with endothermic motors.

The diffusion of power tools and/or batteries has taken place on products destined for the so-called consumer segment of the market and in the so-called “prosumer” and professional segment. Such tools or vehicles require significant electrical power for their operation or charging. The Applicant has observed that often the manufacturers which produce tools and/or small vehicles with electrical power supply, in particular but not limitedly for gardening or agriculture, have different types of tools and vehicles in their catalogue, and for the same type, they have different versions of the same tool in their catalogue characterized by increasing powers and/or sizes.

The batteries are often not directly produced by the manufacturers which produce tools or vehicles for gardening or agriculture; in fact, such batteries are typically purchased from third parties.

These same manufacturers have several accessories in the catalogue with mains power supply, provided with the classic power cord that must be connected to a wall socket or a mobile socket to allow the accessory to be powered.

The use of different batteries for different applications is in principle inconvenient. Although it is unthinkable, especially where the manufacturer has tools and/or vehicles for gardening or agriculture in its catalogue characterized by significantly different powers, to have a single type of battery, in principle it would be preferably for the manufacturer to have a number of different batteries kept as small as possible, and to have the possibility to adapt the number of batteries to be used in accordance with the specific type or version of tool.

The batteries are recharged with chargers which are often dedicated to a certain type of application. The chargers work by supplying a certain direct current, which is a function of the type and/or the capacity (Ah) of the battery to be charged. Although very powerful chargers, in terms of the current which can be supplied, can be able to charge even small capacity batteries, it is true that high capacity batteries can not be recharged by low power chargers. In principle, and in accordance with what happens occurs for batteries, it would be preferable for the manufacturer to have the least number of different types of chargers.

Since various accessories or tools, electric or rechargeable, are often outside the convenient range of a power outlet necessary to power them or to charge the batteries thereof, there is a need to have a transportable source of energy.

What are called “power bank” devices are known, which are small batteries intended to charge small tools, typically through DC and low-voltage ports.

Motor generators are known, which have the drawback of the emission of exhaust gases during their operation. Motor generators cannot be used indoors, unless adequate ventilation or exhaust of the gases generated in use is provided. Furthermore, motor generators are noisy, and this places a limit on their use in quiet environments or during public holidays or at night.

The need encountered by the Applicant is to have a power supply device for power tools of significant power, which can provide the latter with sufficient electrical power and solve the drawbacks of the aforementioned devices.

US2014/0152099A1 describes a movable trolley for supporting and moving equipment such as an electromedical device or a computing device. To ensure the operating continuity of the equipment, the movable trolley includes a power supply assembly with removable batteries and a battery charger configured to selectively charge the batteries of the power supply assembly. The movable trolley further includes a battery control system configured to supervise the charging and discharging of each battery of the power supply assembly.

US2020/0395771A1 describes an emergency device for electrical power supply provided with wheels and arranged for the application of replaceable-type battery units. The device comprises a control unit, a connection part for the battery units and an output unit by means of which the electrical energy of the battery units can be supplied to a load. The control unit is configured to select the battery unit having a residual charge amount which is the smallest among the battery units applied to the device and which is however equal to or greater than a predetermined amount, and is configured to connect the selected battery unit to the output unit.

US2021/0021139A1 describes a portable multi-voltage power supply system, comprising a plurality of energy storage devices, a conversion switch and an output connector for the connection to a load. The conversion switch is configured to connect the plurality of energy storage devices in series, in parallel, and in combinations thereof, to obtain a desired output voltage. The portable power supply system is capable of supplying, by means of a power socket, power to external power tools and powering auxiliary equipment on board the portable power supply system, such as air compressors, sensors and control circuits, radios and lights.

US2009/0230783A1 describes a portable solar power unit including a battery with associated electronics and a solar panel in a case with a shoulder strap. The portable unit includes a plurality of charging ports for accessories and is capable of supplying compressed air and starting voltage for car engines.

US2019/0386497A1 describes a chargeable power supply for powering an electric tool such as a dynamometer gun. The portable power supply comprises a protective case, a first battery element and a second battery element, the battery elements being housed in the protective case. The portable power supply further comprises an input electrical connector for the electrical connection to an external power supply source, an output electrical connector for the electrical connection to the power tool, and a battery charger coupled to the input electrical connector and capable of simultaneously charging the battery elements. The portable power supply further comprises a manual switch configured to allow one among the first battery element and the second battery element to be electrically coupled to the output electrical connector.

US2018/0323621A1 describes a portable type power supply device capable of electrically connecting to two battery packs housed in dedicated housings of the power supply device. The power supply device is configured to operate a sequential charging of the battery packs, whereby the power supply device charges the first battery pack until the first battery pack is fully charged and then charges the second battery pack until the second battery pack is fully charged.

US2019/0109478A1 describes a portable type power supply device comprising an adapter and two battery packs. Each battery pack comprises lithium-ion cells and a plurality of connection terminals for powering a power tool in direct current.

### Objects

An object of the present disclosure is to describe a power supply device and a corresponding method which allows to power electric tools and/or electric vehicles, or electric charging, in a convenient and safe manner.

In particular, it is an object of the present disclosure to describe a power supply device and a corresponding method which allow to optimize the charging and discharging process of batteries present on board the power supply device itself.

In particular, it is an object of the present disclosure to describe a power supply device and a corresponding method which allow a rapid replacement of the batteries contained therein, so that it is possible to extend the duration of the power supply provided and/or so that it is possible to provide a rapid replacement of the batteries in the event of failure.

It is further an object of the present disclosure to describe a power supply device and a corresponding method which allow to reduce, as far as possible, the number of different types of batteries which must be produced in order to be able to supply power to a given variety of tools and/or vehicles, in particular—but not limitedly—for gardening or agriculture.

It is further an object of the present disclosure to describe a power supply device and a corresponding method which allow to reduce, as far as possible, the number of different types of chargers to be produced for a certain variety of tools and/or vehicles, in particular for gardening or agriculture.

It is further an object of the present disclosure to describe a power supply device and a corresponding power supply method such that, in use, no exhaust gas is produced and/or no substantial noise is produced.

It is further an object of the present disclosure to describe a power supply device and a corresponding method which allow a safe activation of at least one power output on which a considerable amount of electrical power is provided.

It is further an object of the present invention to describe a power supply device and a corresponding method which allow to keep the power needed for charging the batteries limited, and which allow to reduce, as far as possible, the electronic intelligence needed on a battery charger.

It is further an object of the present invention to describe a power supply device and a corresponding method which allow, with respect to the solutions known in the state of the art, advantages in terms of useful life of the batteries.

It is further an object of the present disclosure to describe a power supply device and a corresponding method which allow an increase in the thermal efficiency of the electrical power supply by means of the batteries, limiting the possible energy dissipations.

It is further an object of the present disclosure to describe a power supply device and a corresponding method which allow the implementation of diagnostic functions about the state of the batteries, it being possible to execute a continuous monitoring of voltage and current during the charging and discharging steps.

It is further an object of the present disclosure to describe a power supply device and a corresponding method which allow some batteries to be used not only within the power supply device, and therefore for the indirect power supply of one or more devices, but also for the direct power supply of a battery-powered device, reaching a high operational flexibility.

### FIGURES

Some embodiments of that which forms an object of the present disclosure are disclosed below. The description refers to the appended figures, which relate to non-limiting embodiments; a brief disclosure of such figures is provided hereinbelow.

FIG. 1 illustrates a schematic diagram of a power supply device in accordance with the present disclosure.

FIG. 2 illustrates a first perspective view of a first embodiment of a power supply device in accordance with the present disclosure.

FIG. 3 illustrates a second perspective view of the first embodiment of the power supply device.

FIG. 4 illustrates a third perspective view of the first embodiment of the power supply device, in an open configuration.

FIG. 5 illustrates a first perspective view of a second embodiment of a power supply device in accordance with the present disclosure.

FIG. 6 illustrates a second perspective view of the second embodiment of the power supply device.

FIG. 7 illustrates a third perspective view of the second embodiment of the power supply device, in an open configuration.

FIG. 8 illustrates a perspective view of a third embodiment of the power supply device in accordance with the present disclosure.

FIG. 9 illustrates a perspective view of a first accessory removably connectable to the power supply device when in the third embodiment.

FIG. 10 illustrates a perspective view of a second accessory connectable to the power supply device when in the third embodiment.

FIG. 11 illustrates a perspective view of a third accessory connectable to the power supply device when in the third embodiment.

FIG. 12 illustrates a perspective view of the power supply device in the third embodiment and in which the third accessory is coupled to the aforesaid device.

FIG. 13 illustrates a perspective view of a fourth embodiment in accordance with the present disclosure.

FIG. 14 illustrates a perspective view of the fourth embodiment of the device in accordance with the present disclosure, in an open configuration and with an accessory coupled thereto.

FIG. 15 illustrates a perspective view of the fourth embodiment of the device in accordance with the present disclosure, in a closed configuration and with a further accessory coupled thereto.

FIG. 16 illustrates a circuit diagram of the control unit present on board the aforesaid power supply device.

FIG. 17 illustrates a circuit diagram of a discharge management module of one or more batteries; the discharge management module is part of the control unit.

FIG. 18 illustrates a circuit diagram of a battery, in which the presence of a control line is highlighted which allows the activation of a solid-state switch for enabling charging the cells contained in the battery.

FIG. 19 illustrates a brief flowchart of a control related to enabling the activation of one or more power users.

FIG. 20 illustrates a brief flowchart of a control related to a number of batteries needed to provide an activation of one or more power users.

FIG. 21 illustrates a brief flowchart of a control related to a voltage and/or charge disparity control between two or more batteries.

FIG. 22 illustrates a principle diagram of a charging circuit of a first battery and a second battery, in which there is a pair of bidirectional power switches.

FIG. 23 illustrates a principle diagram of a discharging circuit, in which a first and a second battery supply a power user. Also in this case, there is a pair of bidirectional power switches.

FIGS. 24 to 28 illustrate possible circuit configurations which allow the aforesaid bidirectional power switch to be made.

FIG. 29 illustrates in section a configuration of a casing housing an electronic board for the control of the batteries present on board the power supply device.

FIG. 30 illustrates a first non-limiting embodiment of a current switch circuit, comprising a unidirectional power switch.

FIG. 31 illustrates second non-limiting embodiment of a current switch circuit, comprising a unidirectional power switch.

FIG. 32 illustrates a simplified diagram of a power switch circuit.

FIG. 33 illustrates a time diagram of an electrical power absorbed by at least one power user, in which a control unit intervenes to cause a limitation of the maximum power deliverable by at least one battery connected to said at least one power user immediately when a maximum power value deliverable by said at least one battery is exceeded.

FIG. 34 illustrates a time diagram of an electrical power absorbed by said at least one power user, in which the control unit intervenes to cause a limitation of the maximum power deliverable by at least one battery connected to said at least one power user only following a predefined time interval.

FIG. 35 illustrates an overall circuit diagram of an embodiment of the control unit in which a plurality of unidirectional power switches are present.

### DETAILED DESCRIPTION

### The Power Supply Device

The present disclosure first describes a power supply device 500. Such a supply device 500 is configured to supply at least one power user 101, 102 of electrical type.

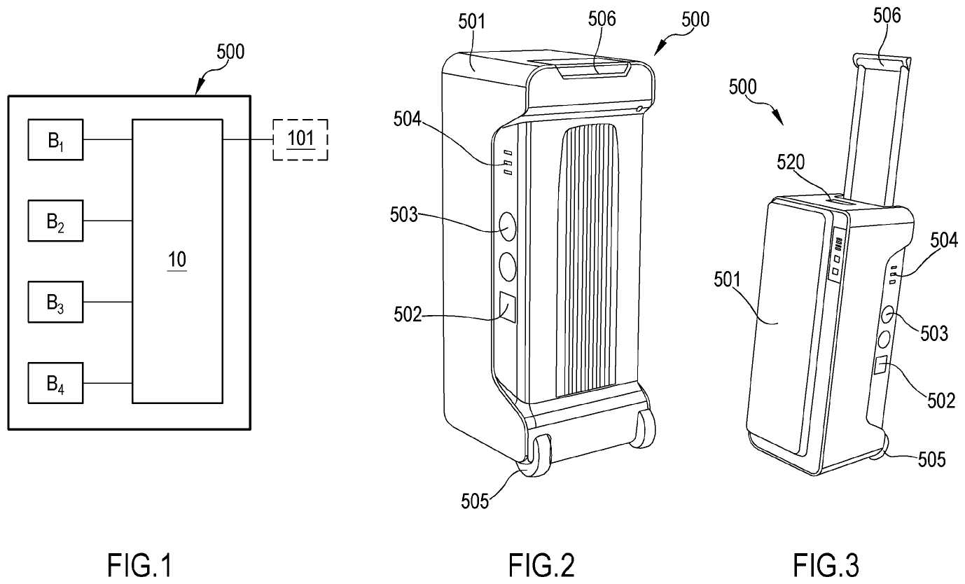

An embodiment of the power supply device 500 is schematically depicted in FIG. 1. In such an embodiment, the power supply device 500 comprises a plurality of batteries B1-B4 and a control unit 10, which is operatively connected with the plurality of batteries B1-B4, so as to control the discharging and/or charging thereof in accordance with the methods which will be described in greater detail below. The batteries B1-B4 are modularly connected on the power supply device 500. As better clarified in the following description portion, this means that the batteries can be connected or disconnected individually or in a multiplicity, so as to provide a variable amount of electrical power available for powering one or more electrical-type power users.

FIGS. 2, 3 and 4 illustrate a first non-limiting embodiment of the power supply device 500. Such an embodiment in particular relates to a transportable device, i.e. intended to be able to be moved by a user. The power supply device 500 comprises a casing 501, which is substantially rectangular in shape, with chamfered corners.

Preferably, but not limitedly, the casing 501 is made of plastic material or fibreglass or a mixed material comprising (also in layers) a plastic material and a fibreglass. The use of plastic material allows to limit the overall weight of the casing 501, and therefore of the power supply device 500. Since the Applicant has devised the power supply device 500 to be used in applications in the external environment, the use of plastic material allows to reduce the risk of rust formation and places the electrical components contained within the casing 501 protected from at least sprays of dirt and water.

A particular embodiment for the casing 501 is characterized by protection against dust and heavy water spray or immersion, for example according to the degree of protection IP 56, or IP 66 or IP67.

On the casing 501, in particular on an accessible portion of said casing, a plurality of power outputs 503, in the form of a power outlet, and a charging inlet 502 are operatively arranged. The plurality of power outputs 503 and the charging input 502 are connected to the plurality of batteries B1-B4 by means of the control unit 10. For the purposes of the present disclosure, “operatively accessible” means that the power outputs 503 are made accessible to a user during the normal use of the power supply device 500.

In a particular embodiment the power supply device 500 comprises a first and a second power output 503, respectively configured to power a respective first power user 101 and a second power user 102. In an embodiment, the power supply device 500 is configured to allow, in particular by means of the control imposed by the control unit 10, the alternative or combined selection of the activation of the first power output 503 and the second power output 503. The two power outputs are therefore independently controllable.

A plurality of low power outputs 504, in particular of USB type or similar, is provided on the casing 501 substantially near the power outputs 503.

The particular embodiment of the power supply device 500 illustrated in FIGS. 2 and 3 is of trolley type, and is for this purpose provided with a plurality of wheels 505, in particular one pair of wheels. The wheels 505 are preferably configured to rotate independently and are positioned in a lower portion, particularly a lower angular portion, of the casing 501.

In order to promote the transportability of the power supply device 500, a handle 506 is slidably arranged with respect to the casing 501. The power supply device 500 comprises a first configuration in which the handle 506 is retracted within the casing 501 and a second configuration in which the handle 506 is extracted from the casing 501.

The handle 506 comprises a pair of longitudinal bars adapted to be introduced and extracted at least partially from the casing 501 and a crossbar (for example rubberised) arranged between the longitudinal bars, in particular substantially at said longitudinal bars.

In the latter configuration, the user grabs a crossbar of said handle 506 and drags the power supply device 500 on the ground causing a rotation of the wheels 505.

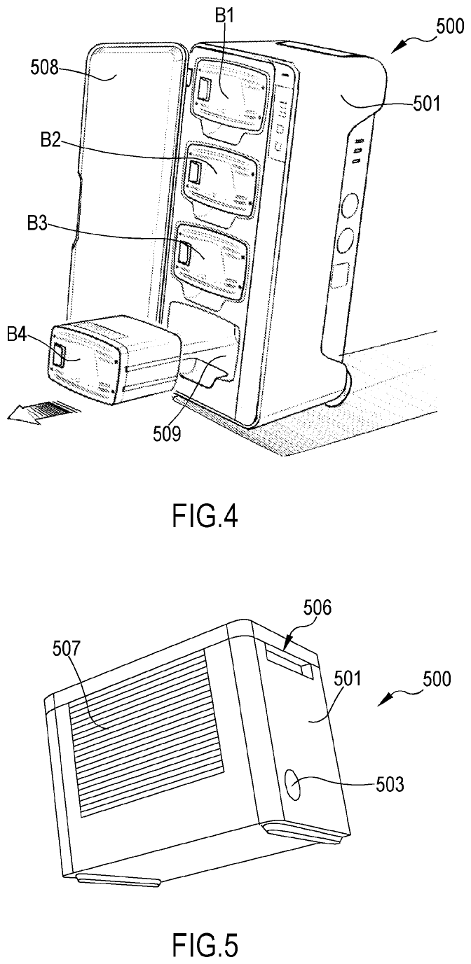

The power supply device 500 further comprises a door 508 which allows access to the plurality of batteries B1-B4. In FIG. 3, the supply device 500 is depicted with a door 508 closed. In FIG. 4, on the other hand, the power supply device 500 is shown with the door 508 open and with a battery B4 extracted from a respective compartment.

The door 508 can also be made of plastic material and, in an embodiment, can be at least partially transparent or translucent, so as to allow the user to view the possible presence or absence of one or more of the batteries of the plurality of batteries B1-B4 without necessarily opening the door itself. The door 508 is hinged substantially at one of its end sides. It can be opened and closed by rotation about the hinging axis.

In an embodiment, compartments 509 are made inside the power supply device 500 adapted to each contain a respective battery. Alternatively, there can be a single compartment capable of containing a plurality of batteries. Preferably, an embodiment of the power supply device 500 is characterized in that each of the compartments 509 has a cross-section whose shape substantially follows the shape of the battery. The compartments 509 are arranged in a single column. The compartments 509 are configured and specifically intended to allow the extraction of at least one battery, or of a plurality of batteries B1-B4, by means of a substantially linear translation.

Although such a technical feature is not intended to be limiting, in an embodiment, each of the compartments 509 is uniquely identified so as to allow the battery installed therein to be uniquely identified. This is particularly useful where the power supply device 500 is provided with a feature for specifically identifying a non-functioning or discharged battery (see below in the description).

At the bottom of each compartment 509, or—in the case of a single compartment—at the bottom of the compartment 509, there is a power connector which in use couples with at least one pair of terminals present on the respective battery. Such terminals are those which, in use, provide electrical energy to one or more of the power users.

The door 508 comprises a closed configuration, in which it prevents access to the compartments 509, and an open configuration in which access to the compartments 509 is possible for the user. In the closed configuration, the door 508 determines an insulation of the compartments from at least sprays of water and/or dust. The door 508 can comprise a gasket which allows to provide adequate insulation to the compartments 509. The Applicant notes that more generally the door 508 can be configured to allow or prevent access to an internal cavity of the casing 501, not necessarily corresponding to one of the compartments 509.

An alternative embodiment of the power supply device 500 in accordance with the present disclosure is illustrated in FIGS. 5, 6 and 7. Also in this case, at least one power output 503 and one charging input 502 are present on the casing 501. The features and materials of the casing 501 have already been described and therefore are not repeated.

The embodiment of FIGS. 5 to 7 is free of wheels, and is made to be carried by hand by the user by lifting. The casing 501 assumes a substantially box-like shape, and is provided with a first and a second handle 506. Preferably the first and the second handle 506 are arranged in an opposite manner, and preferably are positioned at an upper portion of the casing 501. Said first and second handle 506 are made by means of a recess made on the body of the casing 501. Although in FIGS. 5 to 7 the at least one power output 503 is positioned on a side wall, this is not to be construed in a limiting manner. In fact, in an alternative embodiment, the power outlet 503 can be positioned at an upper portion, in particular at the upper wall (orthogonal with respect to the side walls) of the casing 501.

The side walls, or a bottom part, can preferably end with a pair of feet or with a set of three or four feet, aimed at keeping the bottom wall raised from the ground. In a non-limiting embodiment, the feet are substantially linear in type and extend for at least half, preferably at least ⅔ of the extension of at least one of the side walls.

FIG. 5 illustrates a particular embodiment in which a first foot is formed in a single piece on the side wall or bottom wall of the casing 501, and a second foot is formed in a single piece on the side wall or bottom wall of the casing 501.

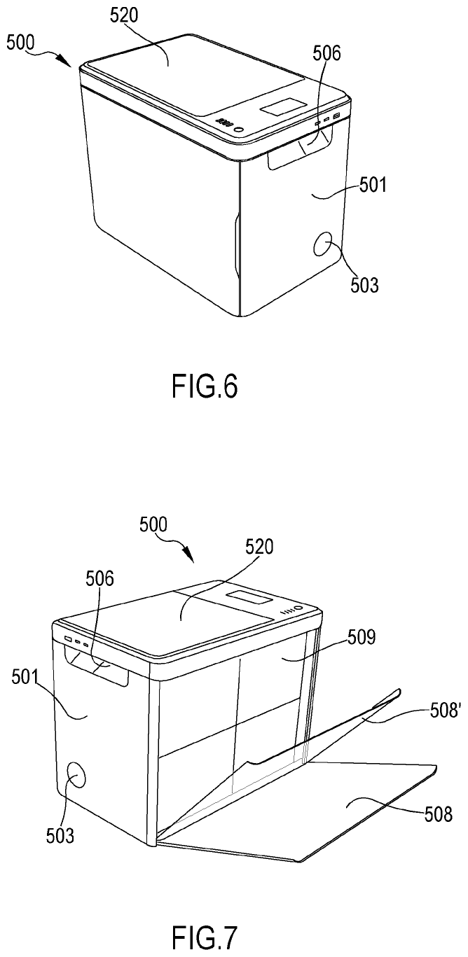

The embodiment shown in FIGS. 5 to 7 is also provided with a door 508. In FIG. 6 the door 508 is in a closed configuration; in FIG. 7 the door 508 is in an open configuration.

In particular, it is noted that the door 508 is associated with a counter-door 508′ which is interposed in use between the compartments of the batteries B1-B4 and the door 508. As in the case of the embodiment of FIGS. 2 to 4, also in this case the door 508 is hinged so as to rotate at its end side. Also in this case, the door can be transparent or translucent.

In the embodiment of FIGS. 5 to 7, the plurality of compartments is arranged on two columns, and more generally can identify a sort of matrix or grid pattern.

The Applicant notes that the rotatable door 508 is only one of the possible embodiments of the door actually conceived. In fact, the Applicant has conceived further variants of the door 508 which instead of being hinged at one side thereof can for example be configured to slide relative to the casing 501 along a substantially axial direction (preferably in vertical use). In this case, the door 508 can be completely disconnected from the casing 501, and is provided with a pair of guides preferably arranged on two parallel and opposite sides of the same device. In a non-limiting embodiment, the door 508 is made by moulding, in particular by injection or co-moulding, and the guides are integral on the body of the door itself. Moreover, the door 508 can be mounted on brackets which allow a rototranslational movement relative to the casing 501.

Although this is not to be understood in a limiting manner, in an embodiment there can be slits on the casing 501 which allow to provide a controlled air exchange with the internal cavity of the casing itself and in particular with one or more of the battery compartments. In combination with such slits, or alternatively, at least one fan can be present. Furthermore, the dissipation of the heat generated in use by the at least one battery present on board the power supply device 500 and/or by the control unit 10 can occur by means of dissipation by irradiation. In such a case, suitable metal heatsinks can be present substantially at at least one portion of the casing 501.

Particular Embodiments with Service Power User

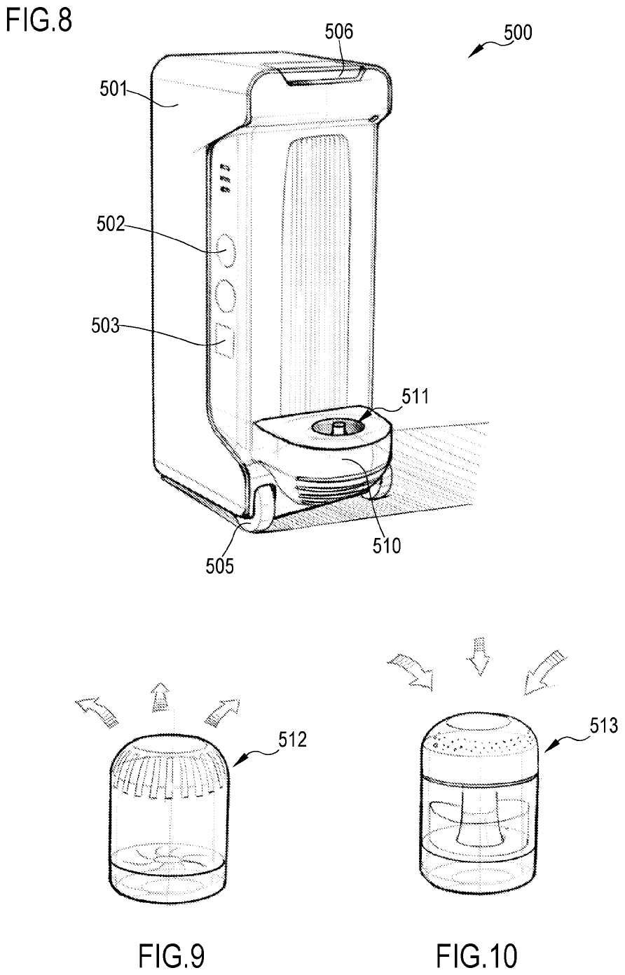

FIG. 8 illustrates a particular embodiment of the power supply device 500 in accordance with the present disclosure. Such an embodiment substantially resumes that of FIGS. 2 to 4. However, in this embodiment there is a service power user 510, which comprises at least one electric machine. In an embodiment, said electric machine comprises an electric motor. The electric machine, in particular the electric motor, is configured to provide driving force to at least one accessory 512, 513, 514 removably connectable to the power supply device at the casing 501.

For the purposes of the present disclosure, “driving force” means a force of a mechanical or electrical nature capable of promoting a movement of a body; in particular, in an embodiment, “driving force” means a mechanical force of rotation or translation or a combination of rotation and translation.

In an embodiment, the at least one accessory 512, 513, 514 is an accessory of the passive type or free of electrical components, in particular free of power electrical components. Such an accessory can include small electrical circuits intended to receive or transmit electrical signals of any nature for applications or purposes other than the primary purpose for which the accessory is intended. For example, the accessory can be a fan mechanically powered by the service power user 510, and can be provided with an RFID chip.

In an alternative embodiment or in combination with the above, the at least one accessory 512, 513, 514 can be an active accessory or with electrical components, capable of transforming in any manner an electrical energy for the purpose for which the accessory itself is conceived and/or substantially intended. For example, such an accessory can be a cooler and be provided with a Peltier cell, in particular as the only cooling or heat exchanger element.

The Applicant notes that FIG. 8 illustrates an embodiment in which a power output 503 is present, and such an embodiment is therefore configured to allow the power supply of at least one further power user 101, 102. It is noted here that the Applicant has also conceived a particular embodiment of the power supply device 501, without power outputs 503; this embodiment is therefore exclusively intended to power the service power user 510.

Preferably, such an electric motor is a direct-current electric motor; this is convenient since the batteries B1-B4 supply a direct voltage. The electric motor can be of the radial flow or axial flow type.

In a preferred but non-limiting embodiment, the service power user 510 is arranged at substantially one end portion of one side of the casing 501 and is arranged so as to be readily accessible.

The electric motor is enclosed by the casing 501 but a shaft 511 is accessible, connected to the electric motor, which allows the actuation—in particular the actuation in rotation—of one or more accessories which will be better described in the following description portion.

In the embodiment of FIG. 8, it is noted that when the power supply device 500 is left in rest configuration and rests entirely on the ground, the shaft 511 extends substantially vertically and therefore rotates about a substantially vertical axis thereof.

In a non-limiting embodiment, the shaft is arranged at a connector of the power supply device 500, which allows the aforesaid one or more accessories 512, 513, 514 to be coupled. Such a connector is in particular a proprietary type connector. Such a proprietary connector in the embodiment of FIG. 8 is of recessed type, but this is not to be understood in a limiting manner. The connector, which has its own end profile, is configured to maintain the shaft 511 within the end profile, optionally in a recessed position. This allows to reduce the risk of unwanted contact with the shaft 511 and promotes the reduction of accidents even if such a shaft 511 is operated in rotation without the coupled accessory 512, 513, 514.

The removable coupling which is made between the connector and the accessory does not require tools; thanks to this technical feature it is possible to easily and quickly replace one or more accessories on the connector. In particular, the connector is configured to retain the at least one accessory 512, 513, 514 in a predefined, in particular fixed, position with respect to the casing.

The removable connection which is created between the power supply device 500 and the respective accessory 512, 513, 514 at the connector can advantageously be a snap and/or screw type connection, and/or bayonet and/or with translation, preferably linear.

FIG. 9 illustrates a first accessory, in particular a fan 512. The fan 512 comprises a fan enclosed in a casing e.g., made of plastic material. Such a casing can be at least partially transparent. The casing is provided so as to protect the user from intercepting one or more portions of the fan when in rotation. The fan 512 is in particular an axial fan. The casing is provided with a plurality of slits from which the air pushed by the fan exits in use. The fan preferably pushes the air from the bottom to the top.

The fan is provided with a spindle (counter-shaft) which engages the shaft 511 of the service power user 510 when the accessory is removably coupled to the connector.

FIG. 10 illustrates a second accessory, in particular an aspirator. The aspirator 513 also comprises a fan enclosed in a casing for example made of plastic material. Such a casing can be at least partially transparent. The casing is provided so as to protect the user from intercepting one or more portions of the fan when in rotation. The fan of the aspirator 513 identifies an axial-type aspirator. The casing is provided with a plurality of slits from which the air pushed by the fan exits in use. The fan sucks the air preferably from the bottom upwards.

In an embodiment, the aspirator 513 comprises a filter, for example a paper or activated carbon filter, useful for the purpose of filtering the air from impurities, microorganisms, bacteria, fungi, or mould. The casing is in this case preferably openable so as to allow the replacement of the filter.

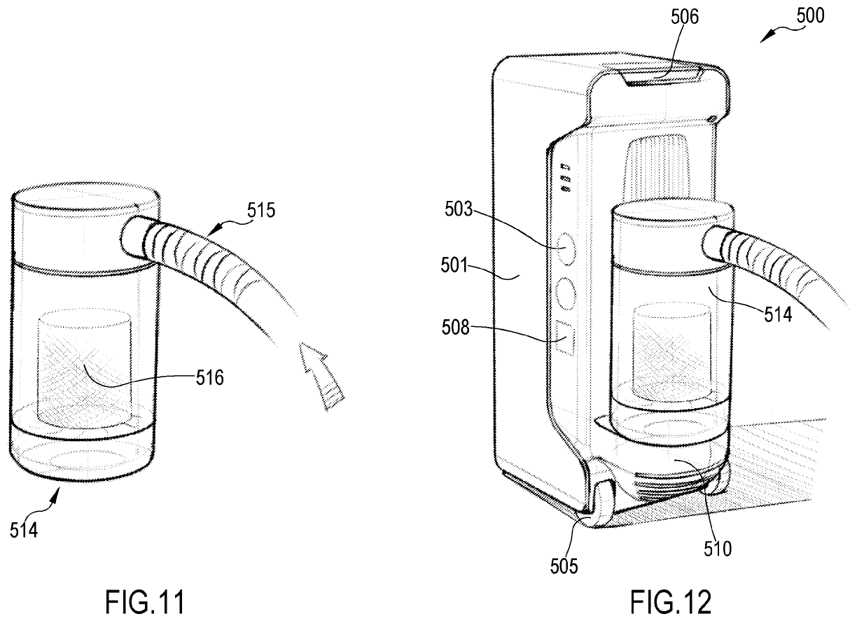

FIG. 11 illustrates a third accessory, in particular a vacuum cleaner 514. The vacuum cleaner 514 comprises a fan enclosed in a casing for example made of plastic material. Such a casing, as in the case of the other two accessories described above, can be at least partially transparent. The casing is provided so as to protect the user from intercepting one or more portions of the fan when in rotation.

The vacuum cleaner comprises a corrugated tube 515 which for the purposes of the present disclosure forms a suction inlet. The corrugated tube is connected 515 at an upper-side portion of the casing.

Within the casing there is a filter 516 which is operatively interposed between the fan and the corrugated tube 515, so that it is possible to filter the air sucked by the fan before it contacts the fan itself. The casing therefore defines a dust collection cavity, which is retained therein thanks to the action of the filter. Such a filter is preferably of known type and therefore its technical features are not described here. In an embodiment, the arrangement of the connection of the corrugated tube 515 with the casing and/or suitable flow diverters can result in a substantially cyclonic air flow within the casing.

The fan is also in this case located in the lower portion of the vacuum cleaner, and is provided with a spindle which couples with the shaft 511.

FIG. 12 illustrates a configuration in which the vacuum cleaner 514 is connected to the power supply device 500.

In use, a user activates—by means of a power command—the power supply of the service power user 510 and part of the electrical energy stored in at least one of the batteries of the plurality of batteries is supplied to the motor of the service power user 510 upon the control performed by the control unit 510.

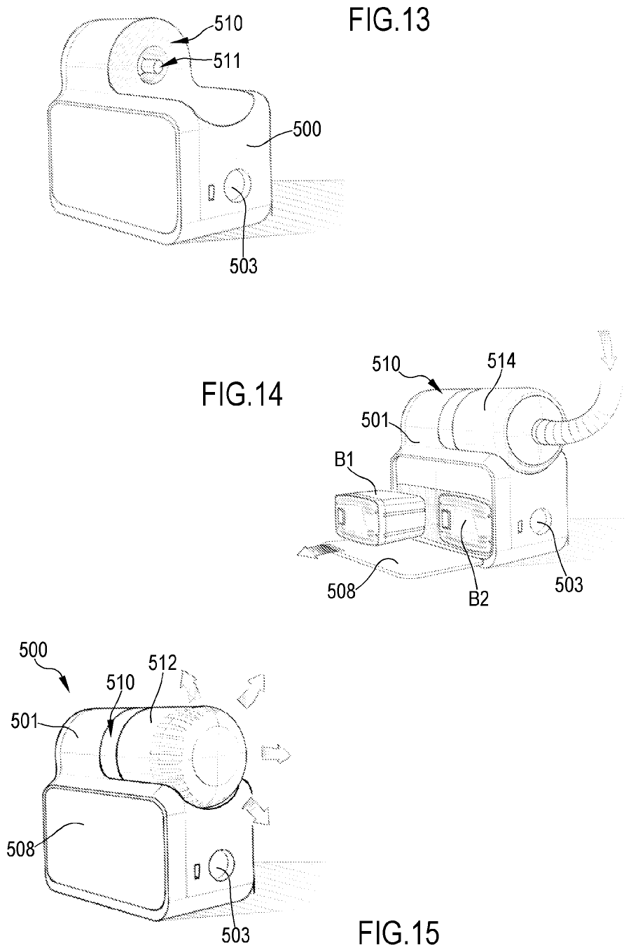

FIGS. 13, 14 and 15 illustrate a further embodiment of the power supply device 500 in accordance with the present disclosure. Unlike that described above, this embodiment has a service power user 510 which is arranged in a substantially upper portion of the casing 510. FIG. 13 clearly shows the shaft 511 which is accessible at the recessed connector of the service power user 510.

FIG. 14 illustrates the power supply device 500 provided with a vacuum cleaner 514 connected to the service power user 510. The vacuum cleaner 514 has features similar to those of the vacuum cleaner of FIGS. 11 and 12, and therefore such features are not repeated again. It is noted, however, that the vacuum cleaner 514 illustrated in FIG. 14 has a substantially axial inlet of the corrugated tube 515 with respect to the fan, and is positioned at a top of the head portion of the casing. FIG. 14 illustrates a particular configuration of the power supply device 500 in which the door 508 is opened and one (the battery identified by reference B1) of the two batteries B1-B2 which contribute to powering the at least one power user 101, 102 and/or the service power user 510, is partially extracted from the respective seat.

FIG. 15 illustrates an embodiment of the power supply device 500 in which a fan 512 is connected to the service power user 510. The features of the fan have already been described and are therefore not repeated here.

The type of accessories illustrated in the accompanying drawings is not to be construed as limiting, in particular, in fact, further accessories can be connected to the service power user 510; a non-exhaustive list of such accessories is provided below:
refrigeration machinery, including fluid compressor and/or Peltier cell refrigeration machinery,
heating devices, such as hair dryers, small ovens, plates for heating food by induction;
actuators configured for drilling (drills), and/or cutting (saws) and/or sanding (sanders) and/or bending, and/or lifting, and/or for generating electric current (alternators) and/or compressing fluids (air compressors, fluid pumps, for example self-priming pumps for gardening applications);
scintillators.

In a particular embodiment, the accessory 512, 513, 514 comprises at least one identification chip, which contains electronic data identifying at least one feature of the accessory 512, 513, 514. Preferably, but not limitedly, the identification chip is of the wireless type; in a preferred embodiment the chip is of the passive type; alternatively the chip can be of the semi-active or active type.

The use of such a chip allows to more easily detect any malfunctions of the accessory itself, simply by analysing the behaviour of voltage and/or current absorption, therefore analysing the absorption of electrical power by the electric motor of the service power user 510.

### Malfunction Identification Module

In a specific embodiment, the power supply device 500 comprises an identification module, preferably contained within the casing 501 or near an outer surface of the casing 501. The identification module is electrically (or more generally operatively) connected to the control unit 10.

The identification module is configured to receive data of at least one feature of the accessory 512, 513, 514, so as to be able to detect suddenly, by analysing the voltage and/or current absorption behaviour, thus analysing the electrical power absorption by the electric motor of the service power user 510, if the accessory 512, 513, 514 has a malfunction (e.g., fan seizure).

Preferably, the identification module operates according to a wireless technology, and for this reason, also so as to contain the transmission power needed to interrogate the identification chip of the accessory 512, 513, 514, it is arranged substantially at the service power user 510.

The identification module is configured to transmit at least part of the data of the at least one feature of said accessory 512, 513, 514 received by the chip to the control unit 10. The latter is configured to electronically detect any malfunctions of said accessory 512, 513, 514 by electronically comparing, optionally substantially in real time, current and/or electrical voltage absorption data by said at least one service power user 510, with said data of said at least one feature of said accessory 512, 513, 514.

### Power Output Power Supply

In an embodiment, the power output 503 is configured to provide a direct voltage. Alternatively, the power output 503 is configured to provide an alternating voltage. In the latter case, the power supply device 500 will comprise an inverter. Preferably, such an inverter is arranged downstream of the control unit but the power output 503 is still operatively arranged between the plurality of batteries B1-B4. The purpose of the inverter is to provide on such an output an almost sinusoidal voltage (e.g., modified sinusoidal), preferably at 110 V or 115 V or 220 V or 230 V or 240 V, sufficient to power one or more tools of known type, such as drills, hair dryers, small stereophonic diffusers, televisions, lamps, gardening tools, electric pumps, electric heaters, etc. The alternating voltage generated on the power output 503 is therefore intended to allow the power supply of traditional tools supplied with domestic mains voltage.

Some non-limiting examples of gardening or farming tools can be electro-actuated shears, mowers, sprayers, chainsaws, hedge trimmers, bio-grinders, blowers, aspirators, snow blowers, pressure washers.

The technical features of the inverter are not described herein, since such an inverter can conveniently be an inverter of known type.

However, preferably, the inverter installed on board the power supply device 500 can advantageously be provided with a control terminal useful for controlling the activation or deactivation of the inverter itself. Disabling the inverter itself causes a behaviour substantially similar to an open circuit, with no transmission of electrical power to the at least one power output 503.

### Wireless Interface Module

In a preferred, but non-limiting, embodiment, the power supply device 500 of the present disclosure comprises a wireless interface module 521. Such a wireless interface module 521 is configured to operatively interface with a remote electronic device, such as a laptop computer, a cellular phone, a tablet computer, a remote server.

In a preferred embodiment, the wireless interface module 521 is a radio module, which operates according to standardized communication protocol, e.g., Bluetooth, IEEE 803.11, Bluetooth, ZigBee, WiMax; alternatively or in combination, the wireless interface module 521 operates according to one or more proprietary communication protocols.

The wireless interface module 521 is configured to receive and/or transmit, respectively from and/or to the remote electronic device, usage and/or control and/or alarm data which are associated with the operation of the power supply device 500 itself, the control unit 10 and/or one or more of the batteries of the plurality of batteries B1-B4 when installed on board. The transmission and reception occurs in selective mode, i.e., specifically intended for a selected number (e.g., one) of remote electronic devices.

Conveniently, a software program can be developed which can be installed on the remote electronic device, so that the user can view the data received by the wireless interface module 521, interact there with and, through the software program, transmit control and operation alteration data to the wireless interface module 521.

The usage and/or control and/or alarm data which is received and/or transmitted by the wireless interface module 521 comprises at least datum among power, energy, residual charge, voltage, current absorbed by one or more of the batteries of the plurality of batteries B1-B4, charging or power supply operating configuration of one or more of the power users 101, 102, temperature of one or more of the batteries of the plurality of batteries B1-B4, exclusion and/or lack of one or more of the batteries of the plurality of batteries B1-B4.

A specific embodiment of the power supply device 500 described herein is characterized in that it has a software control function of activating or deactivating the power supply of the at least one power output 503 and/or the service power user 510. The software control is performed by the user by means of their remote electronic device and a control signal (datum or command) is received from such a remote electronic device by means of the wireless interface module 521. By virtue of this function it is possible for example to disable the power supply of the power output 503 leaving the power supply device 500 near children, avoiding the risk that they can suffer electrical shocks deriving from contact with the powered power output 503 or can introduce their hands near the shaft 511 of the service power user 510.

The software control function causes the closing or opening switch of one of the power switches which will be better described in the following portion of the description. Preferably, but not limitedly, the software control function of activating or deactivating the power supply of the at least one power output 503 and/or the service power user 510 has a higher hierarchy with respect to a manual or electronic control which can be performed on the power supply device 500 itself. In an embodiment, the control unit 10 can be configured to enable or disable the software hierarchy control function of the activation or deactivation of the power supply of the at least one power output 503 and/or the service power user 510. When disabled, one control which can be performed directly on the power supply device 500 has a hierarchy which is greater than or equal with respect to controls which can be performed remotely.

### Sensors

The Applicant has conceived a particular embodiment of the power supply device 500 which is provided with at least one, preferably a plurality of, environmental sensors. The following environmental sensors have been indicated by the Applicant as sensors which can be installed on the power supply device: a temperature sensor, a humidity sensor, a light or solar radiation sensor, a barometric pressure sensor. Such sensors are specifically designed to detect environmental parameters substantially at the power supply device 500. The solar radiation sensor can be a light radiation sensor or can be a UV type sensor.

In an embodiment, there is a logical connection between the wireless interface module 521 and said at least one environmental sensor. Thereby, the use and/or control and/or alarm data can comprise temperature and/or humidity and/or brightness and/or barometric pressure data obtained from one or more of the environmental sensors.

On the basis of such data, operations such as the deactivation of the power output 503, or the activation of the power output 503, or the activation or deactivation of the service power user 510 can optionally be decided automatically by the control unit 10.

As will be better clarified in the following portion of the disclosure, in fact, an embodiment of the control unit prefers, in particular in the event of limited power available from the batteries, the power supply of the priority power user 102. Also for the purposes of the present disclosure, the electronic control unit intended to control the aforesaid motor is in turn considered a priority power user. Such a control unit is in particular configured and specifically intended to determine at least one among a power supply, a powering down, and a power delivery, of said at least one traction motor.

### Charging Module for Tools

Preferably, but not limitedly, the power supply device 500 can comprise a charging module for tools, in particular for tools for agriculture or gardening which are self-propelled and/or have at least partially automated control. For example, such tools for agriculture or gardening comprise lawnmower robots.

In a preferred embodiment, the charging module for tools is a wireless charging module.

The charging module for tools is operatively connected to the at least one battery B1 and when present is connected to said plurality of batteries B1-B4.

The charging module for tools is configured to receive, in use, electrical energy from said at least one battery B1, and if present and/or available to power more than one battery of the plurality of batteries B1-B4 and is configured to transfer said electrical energy to a tool, in particular to said tool for agriculture or gardening which is self-propelled or has at least partially automated control, when the latter tool comes into contact with at least one contact present on the tool charging module and/or when said tool is substantially near the tool charging module itself. Advantageously, therefore, the power supply device 500 can act as a charging device intended to allow the power supply of—for example—lawnmower robots, while at the same time allowing the power supply of further power users in a modular and operationally flexible manner.

Modularity with Further Power Supply Devices

In order to make the power supply device 500 even more flexible in its use, the Applicant has devised a particular embodiment of the power supply device 500, described below. It comprises at least one parallel power supply input, configured to allow, in use, a modular operating connection of said power supply device 500 with at least one further power supply device 500.

Such a parallel power supply input is made operatively accessible by the user and is positioned at an easily accessible portion of the casing 501, for example it is positioned near the at least one power output 503. In an embodiment, such an input is at least visually differentiated from said power output 503.

The parallel power input is configured to power said service power user 510 and/or said at least one power user 101, 102 with an electrical energy from at least one battery B1 among the batteries present on board the power supply device 500, and, simultaneously, with an electrical energy from at least one battery of said further power supply device 500.

That is, by means of the parallel power input, the batteries of the two or more power supply devices 500 are operating in parallel. Their currents available to the power users are summed, ideally.

Although this technical feature is not to be interpreted in a limiting manner, in an embodiment the parallel power supply input is connected downstream of the control unit 10 and therefore directly upstream of the one or more power users (first and/or second power users 101, 102, therefore directly upstream of the at least one power output 503, or directly upstream of the electric machine of the service power user 510); in particular it is downstream of the power switch 20s or, in any case, downstream of the last of the controls of safety and/or limitation of the power deliverable by one or more of the batteries. Thereby, if more than one power supply device 500 is connected in parallel and has one or more of the control and/or limitation features described herein, these features will also be maintained following the interconnection of more than one power supply device 500 in parallel.

### Auxiliary Power Supply Sources

A further non-limiting embodiment of the power supply device 500 comprises at least one photovoltaic cell panel 520.

The photovoltaic cell panel 520 is arranged substantially at the casing 501 and/or is movably, optionally removably, connectable to the casing 501, for example by means of a bracket or an adjustable and in particular flexible support.

The photovoltaic cell panel 520 is configured to provide an electrical energy intended for the at least partial charging of the at least one battery B1, preferably intended for the at least partial charging of at least one part of the plurality of batteries B1-B4, if any, and/or intended for the power supply of the service power user 510 and/or the at least one power output 503. The photovoltaic cell panel 520 can thus optionally be connected by means of the control unit 10, to the at least one power output 503 and/or to the service power user 510, by means of for example a voltage transformer or a voltage regulator.

From the operating point of view, the photovoltaic cell panel 520 can be operatively connected downstream of the output of the power supply 30. Thereby, the controls made available by means of the control unit 10 for charging the batteries, described in the present description, are kept unchanged. It is noted in particular that the power supply provided by the photovoltaic cell panel 520 is also combinable with that of the power supply 30. In other words, these two devices can cooperate together to provide power at least for charging the one or more batteries present on board the power supply device.

There is therefore a particular operating configuration for charging the at least one battery B1, and if present the plurality of batteries B1-B4. In such a particular charging configuration, the power supply 30 and the photovoltaic cell panel 520 cooperate together to provide electrical energy intended for charging one or more batteries.

A particular embodiment of the power supply device 500 described herein has a control unit 10 specifically configured to allow the charging of batteries and the power supply of power users substantially simultaneously. Such a particular embodiment the photovoltaic cell panel 520 and the power supply 30 cooperate to charge a first part of the plurality of batteries B1-B4 which is installed on the power supply device 500, and to power, by means of a second part of the plurality of batteries B1-B4 distinct from the first part of the plurality of batteries B1-B4, at least one among the service power user 510 and the at least one power user 101, 102, in particular by means of the at least one power output 503. The first and/or the second part of the plurality of batteries B1-B4 can also comprise only a single battery. The Applicant notes that the specific configuration of the control unit 10 described herein, which is reflected in a specific operating configuration of the power supply device 500, is also applicable to embodiments of the power supply device 500 without the service power user 510, and therefore exclusively intended to allow the power supply of at least one power user 101, 102 through one or more of the power outputs 503.

### Hot Swaps

In a particular and non-limiting embodiment, the batteries B1-B4 can be removed or inserted “hot”. This means that in an embodiment it is possible to extract, or insert, at least one of the batteries B1-B4 of the power supply device 500 without needing to have a complete powering down thereof, and/or (when charging) without needing to disconnect a power supply necessary for their charging. When the power supply device 500 is configured to simultaneously power a plurality of power users of which a first is a priority power user and a second is a secondary power user, the removal or insertion of one or more batteries can be possible without the need to power down at least the secondary power user 101. The priority power user 102 will be kept electrically powered within the limits of the power deliverable by the connected battery (or, if multiple, by the connected batteries). By virtue of this aspect, the operating flexibility is increased.

In particular, the Applicant has conceived a particular embodiment of the control unit 10 which is configured to be operatively connected with at least one power user 101, 102 preferably through a respective first and second power output 503 and with the plurality of batteries B1-B4, and in particular to be operatively connected with at least one among a first battery B1 and/or a second battery B2 forming part of the plurality of batteries B1-B4.

Clearly the plurality of batteries, and in particular the first battery B1 and the second battery B2 are installed on board the power supply device 500, and are intended to power, at least in part, said at least one power user 101, 102, by means of the at least one power output 503, in particular by means of a power supply circuit connected with the at least one power output 503 and configured to withstand the electrical current absorbed by the at least one power user 101, 102. Where present, clearly the first battery B1 and the second battery B2 are intended to power the service power user 510.

The control unit 10 is configured to allow the connection or disconnection of at least one battery of the plurality of batteries B1-B4, in particular of one among the first battery B1 and the second battery B2, from the power supply circuit, without interrupting the power supply provided to the at least one power user 101, 102 and/or without interrupting the power supply provided to the service power user 510.

In particular, the control unit 10 is configured to allow the connection or disconnection of said at least one battery without interrupting the electrical power supplied to the priority power user 102 and to the secondary power user 101, in the latter case if possible in accordance with the availability of charge and/or power or electrical power deliverable by the batteries.

In particular, to avoid causing malfunctions or failures, the control unit 10 comprises a stage of filtering and/or limiting voltage and/or current peaks and/or drops, executing, in use, a filtering and/or limiting of voltage and/or current peaks and/or drops, upstream of the at least one power output 503, and therefore upstream of the at least one power user 101, 102 and/or upstream of the service power user 510.

In a particular non-limiting embodiment, following the disconnection of a battery, the control unit 10 is configured to perform-through its own electrical circuits or in accordance with one or more software routines executed thereby—an automated electronic verification of whether at least one among an electrical power, charge, voltage or current, made available by the at least one battery installed on board the power supply device 500 is sufficient to power the at least one power user 101, 102 and/or the service power user 510.

In particular, in embodiments which envisage a distinction between a priority power user and a secondary power user, such an electronic verification is intended to allow to verify whether at least one among an electrical power, charge, voltage or current, made available by the at least one battery installed on board the power supply device 500 is sufficient to power the at least one among the priority power user 102 and the secondary power user 101.

The control unit 10 is then configured to perform, following said electronic verification, and in accordance with at least one value among an electrical power, charge, voltage or current, made available by the at least one battery residually connected to the power supply circuit, at least one among:
an electronic limitation of a power which can be provided to the at least one power user 101, 102 and/or to the service power user 510 and/or of power absorbable by the power user 101, 102 and/or by the service power user 510, preferably an electronic limitation of the power deliverable to the priority power user 102 and/or the secondary power user 101, and/or of power absorbable by the priority power user 102 and/or the secondary power user 101;
the powering down of the secondary power user 101;
a powering down of the priority power user 102;
a powering down of the service power user 510.

Optionally, the control unit 10 is intended to maintain an electrical power supply of at least itself, and of electrical control circuits of the priority 102 and/or secondary power user 101.

### Battery Technology

In principle, the batteries B1-B4 can be made according to any technology. However, in a particular and non-limiting embodiment, the batteries are of the lithium type. This ensures significant compactness in relation to the overall capacity.

Preferably, but not limitedly, the batteries B1-B4 are of the same type, in particular they—each—have a same capacity (Ah) and/or a same voltage (V).

The batteries B1-B4 are connected in parallel and provide power to one or more of the power users 101, 102 provided through one or more of the power outputs 503. Clearly, when one or more of the batteries of the aforesaid plurality is electronically excluded from the power supply due to a control imposed by the control unit 10, the number of batteries operating in parallel will be consequently reduced.

The fact of having batteries B1-B4 in parallel implies that the voltage which is supplied to the power users is the voltage of each of the batteries B1-B4, while the total current deliverable to such power users is—ideally—the sum of the maximum currents that deliverable by each of the batteries B1-B4. The discharging of the batteries in parallel essentially determines a balanced discharging of all the batteries B1-B4 installed on board the power supply device 500.

In a preferred but non-limiting embodiment, each of the batteries B1-B4 is configured and specifically intended to provide a maximum voltage substantially between 20V and 80V, more preferably substantially between 22V and 48V.

Such batteries B1-B4 also power any other low-power utility with which the power supply device 500 is provided; for example, the batteries B1-B4 power low-power outputs such as USB ports or the like, or small LED lights which are provided on the power supply device 500. In addition, the batteries B1-B4 can be designed to power one or more fans which are arranged inside the casing 501 for cooling the electronic circuits and the batteries.

The batteries B1-B4 are configured to be transported operationally. For the purposes of the present disclosure, this implies that the batteries B1-B4 are not to be understood as batteries intended to remain inside and above all hidden, from the access of a normal user; on the contrary, they are batteries specifically designed to be able to be handled by a user traditionally intended to operate with the power supply device 500; the casing of the batteries is for this purpose intended to isolate the user from accesses to live portions, and is designed for the purpose of being handled safely, in particular during the handling operations necessary for the introduction and extraction of the batteries from the respective compartments inside the casing 510. Therefore, for this reason, the batteries B1-B4 each comprise a casing adapted to be transported and/or stored and/or handled by a user. The at least one cell 43 is clearly positioned inside said casing. The casing of the batteries B1-B4 allows a sufficient level of protection IP, preferably equal to or greater with respect to that guaranteed by the casing 501 of the power supply device 500.

The supply switch 44 which will be better described in the following description portion is positioned inside the battery casing, and each battery of the plurality of batteries B1-B4 comprises a connector, accessible at an end portion of the casing and configured to be removably connected with a counter-connector arranged inside the casing 501 of the power supply device 500.

### Control Unit

As already anticipated above, the power supply device 500 described herein is provided with a control unit—indicated by the reference number 10—which is intended to control the charging and discharging of the batteries B1-B4.

The control unit 10 disclosed herein can comprise various electronic data processing and/or programmable circuits, including a processor of the general purpose type, or an ASIC, or an FPGA, or a PLC, each of which can be programmed with a specific software program loaded onto an integrated memory or operatively accessible by the control unit 10. Such a software program can therefore comprise portions of code which when executed cause the execution of one or more of the steps of the method disclosed herein.

The control unit 10 can comprise several physical sub-portions, each positioned in a different position within the casing 501 of the power supply device 500, where this is convenient for reasons of production convenience, energy efficiency and/or safety.

The control unit 10 is specifically configured and intended to be interposed in use between the plurality of batteries B1-B4 and at least one power user 101, 102 connected to the power supply device 500, and thus to be operatively interposed in use between the batteries B1-B4 and the at least one power output 503 and/or, where present, the service power user 510.

The control unit 10 has a particular configuration of use which determines, in the use of the power supply device 500, the execution of a plurality of steps of a management method for charging and discharging the aforesaid batteries B1-B4 as well as controlling the modes with which the power users 101, 102 and/or with which the service power user 510 is electrically powered.

The present detailed disclosure will not always distinguish between the method and the configurations of use of the control unit 10; this, in order not to become excessively long. It is understood that where a particular configuration is specified for the control unit 10, such a configuration will clearly be equivalent to one or more corresponding steps of a management method for charging and/or discharging one or more batteries, and vice versa.

### Charging Operating Configuration

The control unit 10 firstly comprises a charging operating configuration. In the charging operating configuration, the control unit 10:
selects at least a first part B1 of the plurality of batteries B1-B4, enabling the charge thereof;
causing a selective charging, by a power supply 30 of the first part B1 of the previously selected plurality of batteries B1-B4.

Subsequently, in the charging operating configuration, the control unit 10 selects a second part B2-B4 of the plurality of batteries, enabling the charge thereof, and causes a selective charging, by the power supply 30, of the second part B2-B4 of the plurality of batteries B1-B4.

More specifically, in a first embodiment the first part B1 of the plurality of batteries is a single battery. This means that while the charging of the batteries B1-B4 occurs on one battery at a time, or, for example, in groups of two, in the discharge process following the power supply of the power users 101, 102 and/or of the service power user 510, preferably all the batteries of the aforementioned plurality compete together. The control unit 10 is therefore configured to execute a sequential charging of each of the batteries forming said plurality of batteries B1-B4.

In an embodiment, the control unit 10 is configured and specifically intended to cause a charge of each battery of the plurality of batteries B1-B4 with CCCV mode (constant current, constant voltage). At the beginning of its charge (i.e., starting from a nearly discharged battery configuration), each battery is charged with a constant current, the value of which is established by the control unit. A threshold voltage value is stored in a memory of the control unit 10, or in a memory operatively accessible thereby; when such a threshold voltage value is exceeded, a progressive reduction of the charging current of the battery is determined, up to substantially an ideal value of zero, which substantially corresponds to a full charge.

In an embodiment, in which the control unit 10 selects one battery at a time, among the plurality of batteries B1-B4, the total charging time T_{ch} necessary to charge all the N batteries of the plurality of batteries is given by T_{ch}=N*T_{b}, where T_{b} is the time necessary to charge a battery.

At least one battery of said plurality of batteries B1-B4 can be removed without compromising the operation of the power supply device 500; said battery, when removed (and charged) can be favourably used for further purposes, for example in further power supply devices 500, or even in other tools which support the installation of the aforesaid battery.

### Power Supply Operating Configuration

The control unit 10 further comprises a power supply operating configuration. In the power supply operating configuration, the control unit 10 causes a power supply of the at least one power user 101, 102 (through the power output 503) connected to the power supply device 500 and/or, if present, of the service power user 510, determining, in use, a transfer of electrical energy simultaneously occurring from the plurality of batteries B1-B4 to the at least one power user 101, 102.

This means that when “seen” by the at least one power user 101, 102, the batteries appear connected in parallel. Their overall voltage is therefore, at least ideally, equal to the voltage of each of the batteries of the plurality of batteries B1-B4. The deliverable current is the sum of the currents deliverable by each of the batteries of the plurality of batteries B1-B4. The total electrical power deliverable by the plurality of batteries is given by the sum of the electrical powers deliverable by each of the batteries of the plurality of batteries.

In use, the control unit 10 is configured to operate the power supply operating configuration only when all of the batteries of the plurality of batteries B1-B4, when technically chargeable (see subsequent portions of the disclosure), have been charged.

For this reason, the control unit 10 comprises a plurality of discharge modules 11. Each discharge module 11 comprises a respective discharge diode.

As will be better disclosed below, in an embodiment each discharge module comprises a diagnosis module 11d.

The number of discharge modules 11 is equal to the number of batteries of the plurality of batteries B1-B4. Each discharge module 11 is operatively connected with the power users 101, 102 by means of at least one power switch 20s of controlled type. The power switch 20s is the switch which can be controlled by means of software through the control performed by the user's remote electronic device or directly by one or more commands present on the body of the power supply device 500.

In use, through a control exerted by the control unit 10 and by means of the plurality of discharge modules 11, in at least one particular power supply operating configuration, the discharge of the batteries B1-B4 therefore occurs in a balanced manner. Therefore, in such a particular power supply operating configuration, all the batteries of the plurality of batteries B1-B4 contribute to powering the power users 101, 102.

### Description of the Power Supply for Charging the Batteries

The control unit 10 further comprises a charge module operatively and in particular electrically associated with each battery of the plurality of batteries B1-B4.

The control unit 10 further comprises a power supply input, which is configured to provide electrical power necessary for charging the plurality of batteries B1-B4. In particular, the power supply input is connected (by means of a connector, schematically depicted by the double arrow 16, and therefore removably) to a power supply 30 configured and specifically designed to receive a single-phase alternating voltage in input, for example an alternating voltage at 220V or 240V or 115V, preferably of the sinusoidal type, typical of domestic power supplies. Alternatively, the power supply 30 is configured and specifically intended to receive an alternating three-phase voltage in input, for example at 380V. Still alternatively, the power supply 30 can be configured to select the single-phase or three-phase power supply, also automatically. Suitable electronic circuits, not described in detail, will be present to allow the aforesaid automatic selection. An input of the power supply 30 is connected to the charging input 502. The input of the power supply 30 can thus conveniently be supplied with direct current.

The power supply 30 further comprises a voltage converter which converts the alternating voltage into direct voltage, and thus makes a conversion stage from alternating voltage to direct voltage. Typically, the power supply 30 further comprises a transformer, used with a voltage lowering function.

The power supply 30 can conveniently be provided with electrical protection circuits, of known type and therefore not described in detail.

Optionally, the power supply 30 is disconnectable from the plurality of batteries B1-B4 and the control unit 10, and therefore also from the power supply device 500. In order to keep the power supply 30 as inexpensive as possible, and universally applicable for a large variety of applications or tools, the intelligence of the power supply 30 is limited to the minimum possible.

In the event of a sudden disconnection and/or reconnection of the power supply 30 with the control unit 10, in particular when charging the batteries B1-B4, it is noted that the already accumulated charge is not lost, and the control unit 10 is conveniently configured to prevent damage to the batteries B1-B4, in particular to filter out any voltage surges which may occur.

In a preferred, but non-limiting embodiment, the connection of the power supply 30, and in particular the supply of electrical power to at least one of the batteries of the plurality of batteries B1-B4, determines an electrical disconnection of the at least one power user 101, 102 and/or the service power user. Such a disconnection, in an embodiment, determines an opening of the power switch 20s.

### Inputs and Control Lines for the Batteries

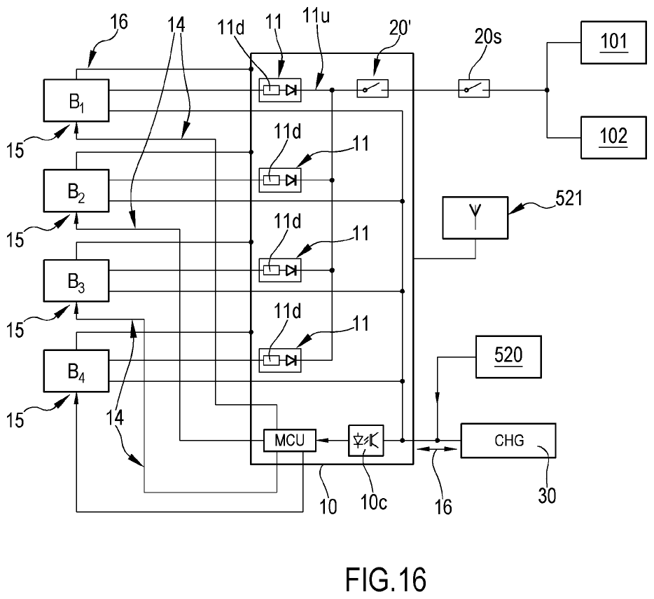

As illustrated in particular in FIG. 16, in an embodiment, each battery B1-B4 is a smart battery, and has a control input 15 powered by a control line 14, on which a battery charge enabling signal is selectively transmitted. The number of control lines 14 is equal to the number of batteries of the plurality of batteries B1-B4. The control input, when an appropriate signal is received, causes a switching of a supply switch 44, preferably a solid-state supply switch 44, which determines the possibility of charging the cells 43 contained in the battery. Vice versa, when such an appropriate signal is not received, it is not possible to proceed with a charging of the cells 43, since such a supply switch 44 is kept open.

For the purposes of the present disclosure, an appropriate signal is to be understood as any type of signal capable of determining a switching of the aforesaid switch; in an embodiment such a signal is simply a signal with a non-zero voltage; in a further embodiment such a signal is a signal provided with an appropriate binary coding.

At the level of the communication protocol for controlling the batteries, any protocol is in principle usable; however, in a non-limiting embodiment, the communication protocol employed by the control unit 10 for the dialogue with further electronic components of the power supply device 500 is of the CANOPEN type. The use of this specific communication protocol is not to be construed as limiting, as in an embodiment other known automation protocols can be provided for the same purpose.

By virtue of this technical feature it is possible to use, for charging the plurality of batteries B1-B4, a substantially generic power supply 30, which could also be advantageously used for further charging operations of batteries not associated with the power supply device 500.

It is noted that in a preferred but non-limiting embodiment, a 1-wire type bus system protocol is used for controlling the plurality of batteries B1-B4 by the control unit 10. Such a protocol exploits a control line 14 for each battery B1-B4 and allows the transmission of data on a single wire with a binary coding.

In particular in which the “0s” are transmitted carrying a 0V bus line signal, or in any case at a low voltage value for a first time interval (preferably, but not limited to, 60 μs), while the “1s” are transmitted with a 0V bus line signal, or in any case at a low voltage level, for a second time interval, lower with respect to the first time interval (preferably, but not limitedly, 15 μs).

The control unit 10 is configured to maintain a substantial complete independence for charging each battery. The assembly formed by the plurality of batteries B1-B4, each of intelligent type and provided with its own charge management system, and by the control unit 10 determines in fact the presence of a plurality of charging sub-modules; if one of the sub-modules should fail, the charging of the battery associated with the aforesaid sub-module would be compromised, but the charging of the remaining batteries of the plurality of batteries B1-B4, would instead not be compromised.

Management of the Power Available from the Batteries

FIG. 20 illustrates a block diagram regarding a specific power management functionality available on the batteries, implemented through the control unit 10. The Applicant has noted that the possibility of effectively and sufficiently lastingly actuating the power users 101, 102 also depends on the number of batteries present on board the power supply device 500.

Indeed, in an embodiment, said M is the maximum number of batteries installable on board the power supply device 500 (in the case of the present detailed description, M=4), the power supply device 500 could also operate with a lower number of batteries with respect to the maximum, although with some limitations.

The following is herein defined:
i: the minimum number of batteries required to enable activation of the priority power user 102, e.g., connected on a first power output 503;
i: the minimum number of batteries required to enable activation of the secondary power user 101, e.g., connected on a second power output 503;
n: number of batteries actually installed on board the power supply device.

It is noted in particular that where the power supply device 500 is provided with a service power user 510 and at least one power output 503 intended to power at least one power user 101, 102, one among the at least one power user 101, 102 and the service power user 510 will be considered a priority power user, while the other among the at least one power user 101, 102 and the service power user 510 will be considered a secondary power user.

In an embodiment, k>i. In fact, also for safety reasons, the possibility of maintaining the activatability of the priority power user 101 is privileged with respect to the possibility of keeping the secondary power user 102 active. As can be clearly seen from the diagram of FIG. 20, the control unit 10 is configured to perform a control of the number of batteries B1-B4 present on the power supply device 500, and to electronically determine the possibility of actuation of at least one priority power user among the plurality of power users and/or the service power user 510, or of a priority power user and a secondary power user among the plurality of power users 101, 102 and/or the service power user 510, as a function of a number of batteries B1-B4 installed on board the power supply device 500.

The block 2001 identifies a control step to check if the number n of batteries B1-B4 is less than i (n<i). If so, neither the priority power user 102, nor the secondary power user 101 (block 2005 and block 2006) can be actuated.

If no, it means that the number n of batteries B1-B4 installed on board is greater than i, and therefore at least the priority power user 102 is enabled.

Such a step is schematically depicted by block 2002. Subsequently (block 2003), a step of verifying whether the number n of batteries B1-B4 installed on board the power supply device 500 is less than k (n<k) is carried out. If so, it means that the number n of batteries is still not sufficient to allow the actuation of the secondary power user 101. For this reason, the priority power user continues to be kept enabled but the secondary power user is kept disabled. If no, the secondary power user is also enabled (block 2004).

For example, in the specific embodiment of the present disclosure, for example, the following conditions i=2; k=3 can apply.

This particular technical feature is well combined with the possibility of performing a previously mentioned “hot” extraction and insertion, since it allows at least the priority power user 102 to keep functioning even if the user extracts the last battery necessary to also maintain the operation of the secondary power user.

With regard to this technical aspect, the Applicant has devised an embodiment of the control unit 10 which is configured to determine a powering down or an electrical power supply of the secondary power user 101, in particular leaving the supply of the priority power user 102 unchanged and a priority, in accordance with at least one value among an electrical power, charge, voltage or current, made available by the at least one battery connected to the power supply circuit.

### Overload Protection of the Power Supply

The control unit 10 is also configured to allow the power users 101, 102 and/or the service power user 510 to operate only when the power supply 30 is disconnected, i.e., only when none of the batteries B1-B4 are in the charging step. This means that as long as the power supply 30 is connected to the control unit 10 and electrical power is absorbed by it, the power supply operating configuration cannot occur.

By virtue of this aspect, the power supply 30 is preserved from overloads; in fact, the current which the power supply 30 is capable of delivering is much lower with respect to the correct one absorbed in use by even one of the power users. Furthermore, the actuation of the power users is only made possible when a consent is provided through a contact circuit 42, for example a button or a key.

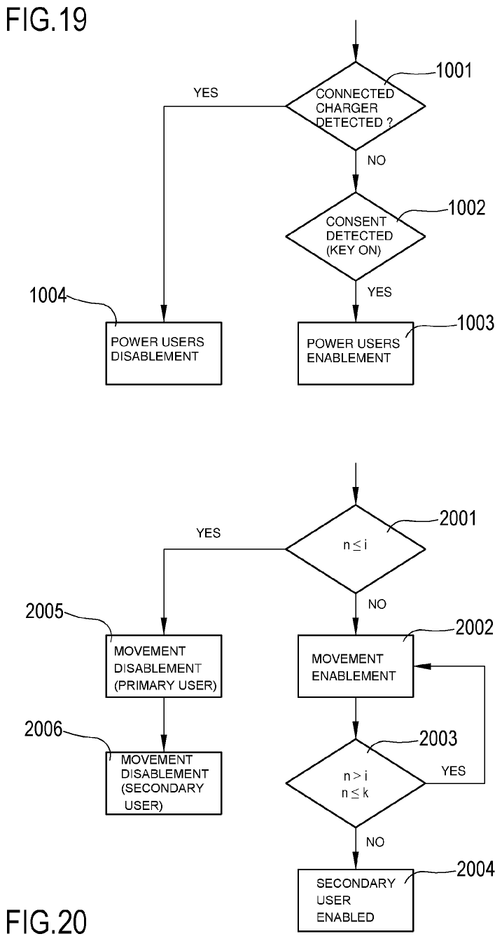

The flowchart of FIG. 19 illustrates the control performed by the control unit 10. The block 1001 identifies a step of detecting the presence of connection of the power supply 30. If the power supply 30 is connected, the possibility of actuating the power users 101, 102 (block 1004) and/or the service power user 510 is disabled. When the power supply 30 is disconnected, the possibility of actuating the power users is enabled, in particular when consent is given by the contact circuit 42, for example a button or key (e.g.: contact key in ON). The control unit 10 therefore verifies whether a consent is given by the contact circuit 42, for example by button or key (block 1002) and, if so, the power users 101, 102 and/or the service power user are enabled. This means that, in use, the presence or absence of the power supply 30 in operating connection is a priority with respect to the consent given by the contact circuit 42, e.g., a button or a key.

From a structural point of view, as shown in FIG. 16, the control unit 10 comprises at least one coupling sensor 10c, which is configured and specifically intended to allow to detect when the power supply 30 is operatively connected with the batteries B1-B4. In a non-limiting embodiment, such a coupling sensor 10c comprises an optocoupler. Alternatively, the coupling sensor 10c can comprise a power sensor configured to detect whether electrical power is transferred to at least part of the batteries B1-B4.

As can be seen from FIG. 16 the control unit 10 further comprises a power switch 20s, preferably solid-state. The power switch 20s is normally closed, so that the electrical energy from the batteries B1-B4 can be supplied to the power users 101, 102 and/or the service power user 510. The power switch 20s switches to the open configuration, interrupting the power supply of the power users 101, 102, only when the coupling sensor 10c detects the presence of the connection of the power supply 30. A control signal is transmitted from the coupling sensor 10c to the power switch 20s with a control line 13c. As can be seen from FIG. 16, therefore, the control of the power switch 20s is determined by the contact circuit 42. A control line 13 controls the opening and/or closing of the power switch 20s and is operatively connected to the charge management module (MCU).

### Discharge Management Module

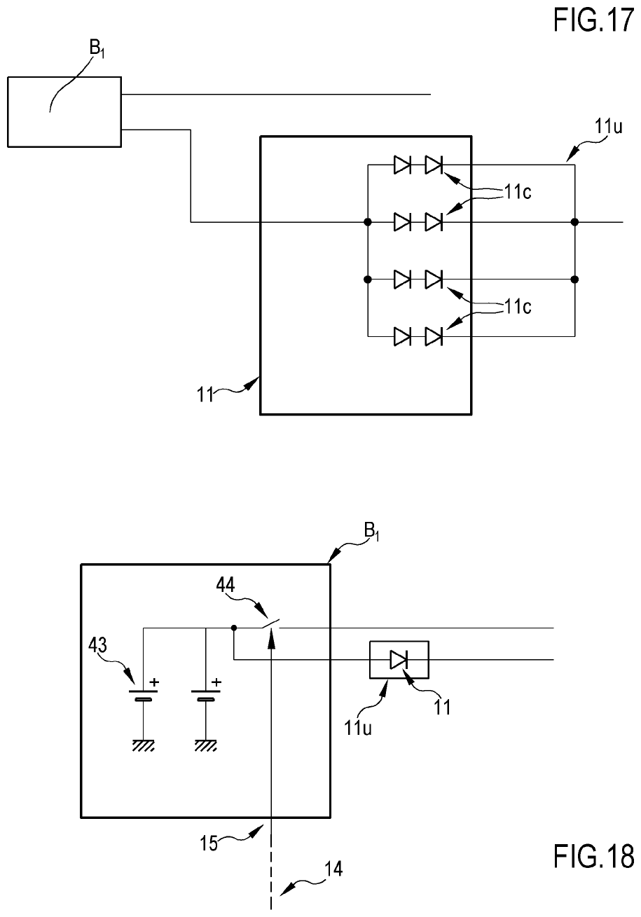

FIG. 17 illustrates a discharge management module 11 for a battery B1 in detail. As can be seen in the figure, the discharge management module comprises an input powered by the battery cells (in FIG. 17, the battery B1) and an output 11u.

Such a module comprises a plurality of diodes 11c therein whose cathode is connected, in particular directly connected, to the input powered by the battery cells, and whose anode is connected to the output 11u. The plurality of diodes 11c is placed in parallel. The function of the diodes is to prevent an undue supply of electrical energy to the cells 43 of the battery B1 through current returns from the output 11u, i.e., to prevent a supply of an electrical current moving from the cathode to the anode of the diode (the cathode of the diode is directly connected to the output 11u).

In an embodiment the discharge management module 11 comprises a plurality of parallel branches, each of which houses at least one diode 11c. In a preferred embodiment, at least one of said parallel branches, and more preferably all of the parallel branches, have a pair of diodes placed in series. This particular configuration allows to extract very high discharge currents in an energy-efficient manner and, at the same time, prevents the breakage of a diode, with consequent significant reverse current flow, from compromising the current flow function (not negligible) to the cells 43 of the battery B1. In such a case, there would still be the second of the diodes in series to prevent the problem. The joint event of a breakage of two diodes in series on the same branch, determining the loss of the supply impediment function of a non-negligible reverse current to the cells 43, is very low. In fact, it is observed that a breakage of two or more diodes, as long as not in series, on several branches, does not cause a loss of the supply impediment function of a non-negligible reverse current to the cells 43.

The diodes 11c can all be of the same type, or of different types.

The Applicant in particular observes that the presence of the diodes 11c prevents that in the power supply operating configuration, in which the batteries B1-B4 operate by supplying current in a parallel configuration, part of the current supplied by one battery can inadvertently end up in another battery of the plurality of batteries B1-B4, damaging it.

In a preferred but non-limiting embodiment, an auxiliary power switch 20′ (supply switch) is arranged in series at the output 11u. Such an auxiliary power switch 20′ is part of the control unit 10 and is connected in series to the power switch 20s.

### Battery Temperature Control

The present disclosure illustrates the possibility of controlling the temperature of at least part of the plurality of batteries B1-B4, mainly so as to prevent the heating thereof above critical temperatures.

Preferably, but not limitedly, the power supply device 500 houses at least one fan intended to cause a cooling of the batteries B1-B4. However, in an embodiment, the power supply device 500 houses a number of fans equal to the number of batteries B1-B4. Where multiple compartments are present, each compartment of the plurality of compartments 509 will preferably comprise a respective fan.

The fans are electrically powered fans, powered by an electric motor operatively coupled thereto.

The control unit 10 is operatively connected, in particular electrically connected, with the at least one fan. When multiple fans are present, preferably the control unit 10 is connected with said fans with a particular operating configuration intended to allow the selective control of an activation and deactivation of each fan independently of the others. Such a connection can in particular entail a presence of a plurality of power supply lines of the aforesaid fans, each operatively connected with a respective fan.

In a preferred but non-limiting embodiment, the control unit 10 implements a control of a rotation speed of the fan, so as to obtain an adjustable cooling of the respective battery. The control of the rotation speed can occur independently for each fan or simultaneously for all fans. Therefore, in an embodiment, the electric motor of the fans is controllable in rotation speed, for example (and not limitedly) by means of a PWM type control or equivalent.

In a preferred but non-limiting embodiment, each of the batteries B1-B4 is provided with a temperature sensor configured to detect the temperature of the cells 43. The control unit 10 is configured to receive a temperature signal transmitted by said temperature sensor; the temperature signal is indicative of a temperature t (C) of a given battery. The control unit 10 is further configured to activate one or more of the fans when the temperature signal transmitted by one or more of the temperature sensors indicates that the respective battery has reached (or exceeded) a temperature t which is higher with respect to a threshold temperature t_{TH}.

In a preferred, but non-limiting embodiment, the control unit 10 is configured to select, preferably automatically, the activation of all the fans even if only one of the sensors detects a temperature t which is higher with respect to the threshold t_{TH}.

Alternatively, the temperature sensors can be present at the at least one compartment 509, and therefore not be installed on board the batteries. Also in such a case, the control implemented through the control unit 10 does not change. The absence of temperature sensors on board the batteries contributes to limiting the production cost thereof.

The Applicant further notes that in an embodiment the batteries are provided with contacts configured to come into contact with respective sockets when the batteries are properly housed in the compartment in an operating position. More precisely, the batteries B1-B4 can be inserted into the at least one compartment 509 by means of translation to an end-stroke position at which the contacts are in contact with the sockets, and electrical energy can be transferred to and from the batteries B1-B4.

### Battery Voltage Control and Imbalance Management

In a preferred but non-limiting embodiment, each battery B1-B4 is provided with a voltage sensor operatively connected to the control unit 10. Alternatively, the control unit 10 comprises a plurality of voltage sensors, each operatively connected to a respective battery B1-B4. Still alternatively, the control unit 10 comprises a single voltage sensor, and is configured to operatively couple the single voltage sensor first with the first battery B1, subsequently with the second battery B2, and gradually up to the last battery B4 of the plurality of batteries B1-B4.

The control unit 10 is configured to electronically compare the voltage value detected on at least one specific battery B1-B4 with a minimum voltage threshold value Vₘᵢₙ. The minimum voltage threshold value Vₘᵢₙ is indicative of the minimum voltage which the battery can have to be able to be charged. If the voltage detected by the voltage sensor is below the minimum voltage threshold value, the battery cannot be charged, and is considered to be faulty, and is therefore excluded from being able to provide a power supply to the power users. This means that in this case the switch 44 of the battery in question, by means of the control line 14, is placed in an open configuration, preventing the passage of electric current.

Preferably, the control unit 10 is configured to execute the aforesaid electronic comparison before the start of charging of each battery.

In fact, the Applicant has found that certain batteries, in particular if lithium or lead-acid, if discharged below a certain voltage value, can be subject to unwanted chemical reactions which determine a significant reduction in the capacity of the battery in subsequent charges. In particular, lithium batteries which are brought below a certain voltage can become chemically unstable with subsequent charges, creating the risk of short circuits in the respective cells. Therefore, the control procedure implemented by means of the control unit 10 allows to increase the safety of charging and use, including the subsequent discharge, of the batteries B1-B4.

To allow this, the control unit 10 comprises a plurality of diagnostic modules 11d, configured to diagnose the operation of a respective battery during the discharge step (i.e., in the power supply configuration). The number of diagnosis modules 11d is equal to the number of batteries of the plurality of batteries B1-B4. FIG. 16 depicts four diagnosis modules 11d having four batteries. Each of the diagnosis modules 11d is arranged upstream of a respective discharge diode; the output of the diagnosis module 11d supplies the anode of the discharge diode. The diagnosis modules 11d can integrate voltage and/or current sensors.

Conversely, the diagnostics during the battery charging operating configuration is managed through a diagnostic battery charge module (reference 14 in the figure). Through the battery charging diagnostic module, the control unit 10 can also be configured to stop charging the battery, and therefore switch to charging the next battery in the plurality of batteries B1-B4, when said battery assumes a voltage value at least equal to a predetermined value Vmax.

Alternatively or in addition to what is disclosed above, the control unit 10 can be configured to execute an electronic control of the charging current supplied to each of the batteries of the plurality of batteries B1-B4. In particular, when the charging step of a battery, or a part of the plurality of batteries B1-B4, is carried out, a current sensor verifies whether the charging current:
exceeds a given maximum safety value Iₘₐₓ, and/or
falls below a minimum charging current value Iₘᵢₙ.

The maximum safety value Iₘₐₓ is determined so as to indicate a value above which a failure of the battery is to be understood, or of the part of the plurality of batteries concerned, determining for example a faux-short circuit condition.

The minimum charging current value Iₘᵢₙ is determined so as to indicate a value below which it is to be understood that the battery is almost fully charged. Such a minimum charging current value can conveniently be associated with a self-absorption value of the battery.

When one of the above two conditions occurs, i.e., when the charging current exceeds the given maximum safety value Iₘₐₓ or falls below the minimum charging current value Iₘᵢₙ, the charging step of the battery, or part of the plurality of batteries B1-B4, is interrupted; it may be possible to move to a subsequent charging step of another battery or another plurality of batteries B1-B4.

Preferably, but not limitedly, if the charging current exceeds the determined maximum safety value Iₘₐₓ, the battery charging step is interrupted immediately.

In an embodiment, if the charging current falls below the minimum charging current value Iₘᵢₙ, the charging step of the battery, or part of the plurality of batteries B1-B4, is interrupted; it may possibly pass to a subsequent charging step of another battery or another plurality of batteries B1-B4.

Alternatively, in order not to stop the (complete) charging too soon, before stopping the charging step of the battery, or part of the plurality of batteries B1-B4, when the charging current falls below the minimum charging current value Iₘᵢₙ, a time equal to or more than a certain waiting time Tw is expected. If the charging current, within the waiting time Tw, continues to be below the minimum charging current value Iₘᵢₙ, the charging step of the battery, or of the plurality of batteries B1-B4, ends; it may possibly pass to a subsequent charging step of another battery or of another plurality of batteries B1-B4.

Preferably, but not limitedly, the control unit 10, by means of the diagnostic battery charging module, is configured to read (for example cyclically, at predetermined time intervals) the voltage value of a battery or of the plurality of batteries B1-B4, both in the charging operating configuration and in the power supply operating configuration. In particular, reading the voltage of at least one battery among the batteries of the plurality of batteries B1-B4 allows to compare the voltage with the threshold voltage value as a result of which the charging current of the battery is progressively reduced.

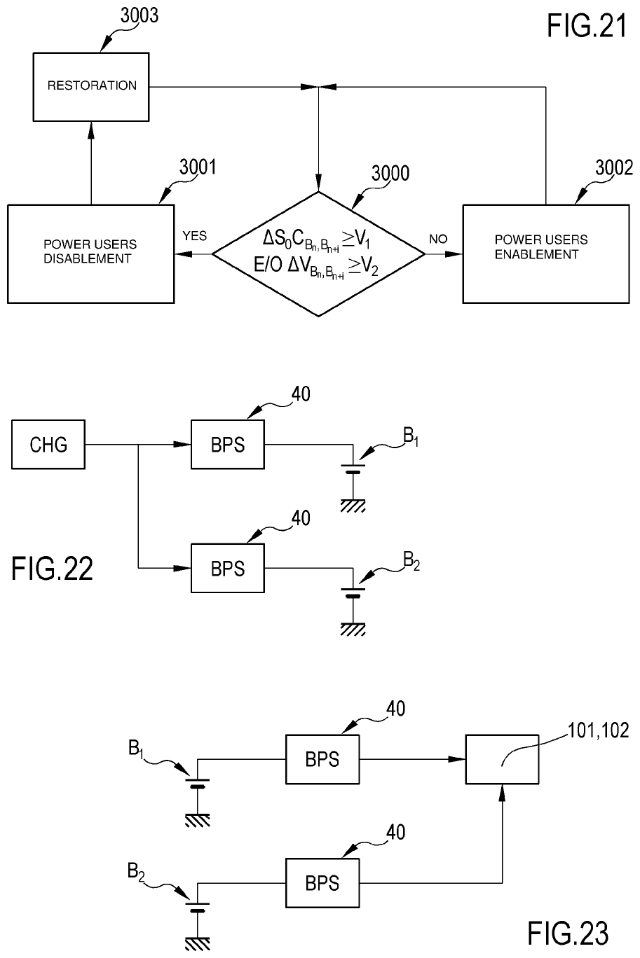

Referring to the block diagram of FIG. 21, in an embodiment the control unit 10 is configured and specifically adapted to execute a voltage difference verification procedure between two or more batteries of the plurality of batteries B1-B4.

Block 3000 identifies a step of verifying voltage and/or charge level imbalances between two batteries Bₙ and Bₙ₊ᵢ. The voltage imbalance between two batteries Bₙ and Bₙ₊ᵢ is indicated by ΔV (Bₙ, Bₙ₊ᵢ).

The charge level imbalance between two batteries Bₙ and Bₙ₊ᵢ is indicated by ASOC (By, Bₙ₊ᵢ).

In the step of verifying voltage and/or charge level imbalances, a comparison is made between the charge level ΔSOC (Bₙ, Bₙ₊ᵢ) between two batteries Bₙ and Bₙ₊ᵢ and a first value Vv1 and/or a comparison is made between the voltage imbalance ΔV (Bₙ, Bₙ₊ᵢ) between two batteries Bₙ and Bₙ₊ᵢ and a second value Vv2.

In particular, the step of verifying voltage imbalances includes verifying if the charge level imbalance ΔSOC (Bₙ, Bₙ₊ᵢ) between two batteries Bₙ and Bₙ₊ᵢ is greater than or equal to a first value Vv1, and/or if the voltage imbalance ΔV (Bₙ, Bₙ₊ᵢ) between two batteries Bₙ and Bₙ₊ᵢ is greater than or equal to a second value Vv2.

Clearly, the above comparison is an electronic comparison.

If so (output S, block 3000), for safety, the power users 101, 102 and/or the service power user 510 are disabled.

If not (output N, block 3000), an enabling (or maintaining the enabling) of the power users 101, 102 and/or the service power user 510 is performed. Such enabling or maintenance of the enabling is depicted with block 3002 of FIG. 21.

As can be seen from the diagram of FIG. 21, after enabling (or maintaining the enabling), the step of verifying voltage and/or charge level imbalances is executed again. It is a loop control cycle, which advantageously allows to have an immediate control of any failures on the batteries.

The block diagram of FIG. 21 illustrates a “recovery” block (block 3003). Such a block corresponds to a recovery step in which an operator executes a replacement of a battery and/or verifies for any malfunctions of the electronics of the power supply device 500. The recovery step can comprise sending a consent command “C” to be able to proceed again with a new step of verifying voltage and/or charge level imbalances between two batteries Bₙ and Bₙ₊ᵢ. It is understood that the aforesaid step of verifying voltage and/or charge level imbalances between two batteries Bₙ and Bₙ₊ᵢ is performed for every n other than i until all the combinations of batteries of the plurality of batteries B1-B4 are completed.

### Limitation of Deliverable Power

In a specific embodiment, the control unit 10 is configured and specifically intended to cause a selection and/or a limitation of a maximum electrical power deliverable by each battery of the plurality of batteries B1-B4. The selection and/or limitation mentioned above are respectively a selection and/or limitation of an electronic type. In particular the control unit 10 is configured to execute a particular procedure whereby selectively, and independently, for at least one battery, and optionally for each battery, of the plurality of batteries B1-B4, a maximum electrical power deliverable by the at least one battery is selected electronically, and optionally by each battery and/or the maximum electrical power deliverable by at least one battery is electronically limited, and optionally by each battery of the plurality of batteries B1-B4. To execute the above, the control unit 10 transmits a power management signal to an electronic control device of the electrical power deliverable by the battery (e.g., solid-state switch) of at least one battery selected among the batteries of the plurality of batteries B1-B4, or if applicable a part or even all of the batteries of the plurality of batteries B1-B4.

In a particular embodiment, the limitation of the maximum electrical power deliverable comprises, and in particular is, a limitation of the current which the battery, or which part of the plurality of batteries B1-B4, or which the entire plurality of batteries B1-B4, can deliver.

This peculiar technical feature allows to avoid overloading phenomena for particular types of batteries, and also allows to use batteries of a significantly different type together without risks. In particular, this peculiar technical feature allows to supply the at least one power user 101, 102 and/or the service power user 510 with a plurality of batteries B1-B4 in parallel even if one of the batteries of said plurality is capable of supplying a greater electrical current with respect to that deliverable by one or more of the other batteries of said plurality of batteries B1-B4.

In particular, the control unit 10 can be configured to prevent, in the power supply operating configuration, the discharge of a given battery of the plurality of batteries B1-B4 (e.g., of the first battery B1) from determining the charging of a given further battery of the plurality of batteries B1-B4 (e.g., of the second battery B2).

In order to envisage for an effective control of the maximum power deliverable by each battery of the plurality of batteries B1-B4 it is preferable that there is continuous monitoring of the voltage and/or current of each of the batteries.

In general, therefore, it can be stated that the present disclosure illustrates a specific embodiment of the control unit 10 which is configured to store at least one datum related to a maximum electrical power deliverable by at least one among the first battery B1 and the second battery B2.

More in particular, the control unit 10 is configured to store a first datum related to the maximum power deliverable by the first battery B1 and to store a second datum related to the maximum power deliverable by the second battery B2.

The control unit 10, alternatively or in combination, is configured to electronically find the datum related to a maximum electrical power deliverable by at least one among the first battery B1 and the second battery B2, in particular by means of an electronic interrogation step of the battery. More in particular, the control unit 10 is configured to electronically find the first datum related to the maximum power deliverable by the first battery B1 and the second datum related to the maximum power deliverable by the second battery B2.

The control unit 10 is configured to electronically limit the electrical power supplied by the at least a first battery B1 and/or a second battery B2 only when the electrical power supplied to the at least one power user 101, 102 and/or the service power user 510 exceeds the value corresponding to said datum, and in particular to the first datum and/or to the second datum. In the event of low electrical power absorption, the control operated by the control unit 10 is “transparent”.

In an embodiment, the control unit 10 determines and/or stores a maximum current value deliverable by each of the plurality of batteries B1-B4. In doing so, in the specific example of the present disclosure in which there are four batteries, the control unit 10 determines and/or stores four maximum current values deliverable: I_{1,max}, I_{2,max}, I_{3,max}, I_{4, max}[A].

It should be noted that for the purposes of the present disclosure, defining a maximum power value deliverable by a battery comprises determining or storing a current value; in fact, given the fact that a battery has a voltage other than 0V, and given the fact that P=V*I, defining a maximum power value comprises defining a maximum current value delivered by a battery.

I₁, I₂, I₃, I₄[A] are defined as the electric currents actually delivered by the first, second, third and fourth battery.

In an embodiment, the control unit 10 executes a routine which includes setting all the batteries at a unique maximum current value Iₑₛₜ equal to the minimum of the four maximum current values deliverable: Iₑₛₜ=min {I_{1,max}, I_{2, max}, I_{3,max}, I_{4,max}}.

In doing so, as long as the current demand of the at least one power user 101, 102 and/or the service power user 510 allows it, each of the four batteries delivers a current I1, I2, I3, I4 which varies with the demand of current of the at least one power user 101, 102 and/or the service power user 510; when the demand of current of the at least one power user 101, 102 and/or the service power user 510 is such as to determine the achievement of the unique maximum current value Iₑₛₜ, each of the four batteries B1-B4 will deliver the same current Iₑₛₜ. In this case the power user 101, 102 and/or the service power user 510 will be able to absorb a maximum current equal to 4Iest.

In an alternative embodiment, the control unit 10 executes a routine which includes setting a maximum current value deliverable for each of the batteries B1-B4.

In doing so, as long as the demand of current of the at least one power user 101, 102 and/or the service power user 510 allows it, each of the four batteries delivers a current I₁, I₂, I₃, I₄ which varies with the demand of current of the at least one power user 101, 102 and/or the service power user 510; when the demand of current of the at least one power user 101, 102 and/or the service power user 510 progressively rises, the lowest of the four maximum current values deliverable I_{1,max}, I_{2,max}, I_{3,max}, I_{4,max}, will be reached. The corresponding battery (suppose, the second battery B2), will begin to deliver a corresponding current value I_{2,max}. The electric current absorbable by the at least one power user 101, 102 and/or the service power user 510 can still grow, until reaching a value such that all the batteries deliver the respective maximum current. The maximum current which the at least one power user can absorb is equal to the sum of the four currents I_{1,max}, I_{2,max}, I_{3,max}, I_{4,max}.

In an embodiment, the control performed by the control unit 10 is immediate. This means that if even only one of the batteries B1-B4 is instantly delivering a greater electrical power with respect to at least a first maximum power value, the aforesaid electrical power limitation is performed. This solution is schematically depicted in FIG. 33.

In an alternative embodiment, the control performed by the control unit 10 is such that cutting the maximum power deliverable is not immediate, but only intervenes following a predefined time interval.

A predefined time interval Δtpₘₐₓ is defined for which the maximum power value can be exceeded by the batteries B1-B4, in particular by each of the batteries B1-B4.

When the electrical power P(t) instantly absorbed by the at least one power user 101, 102 and/or by the service power user exceeds the first maximum power value (if common for all batteries B1-B4) or the maximum power value deliverable for a given battery, the control unit 10 automatically starts to perform an electronic count, until the predefined time interval Δtpₘₐₓ is reached.

Upon reaching the predefined time interval Δtpₘₐₓ, if the electrical power absorbed by the at least one power user 101, 102 and/or by the service power user 510 continues to be higher with respect to the first maximum power value (if common for all the batteries B1-B4) or the maximum power value deliverable for a given battery, the control unit 10 intervenes with said power limitation. This latter solution is schematically depicted in FIG. 34.

In particular, this means that if the electrical power absorbed by the at least one power user falls below the maximum power value deliverable (or the maximum power values deliverable, if different for each battery), the count performed by the control unit 10 is automatically terminated.

By virtue of this technical feature, it is possible to cope with sudden power demand peaks (for example, due to the inrush current of the electric motors) without causing power shortages to the power users, while at the same time ensuring the maintenance of correct control functionality.

Depending on the specific structure of the batteries, the limitation occurs by transmitting an appropriate power limitation signal Sₗᵢₘ from the control unit 10 to one or more of the batteries B1-B4 whose output electrical power must be limited.

In an alternative embodiment, the control unit 10 itself comprises a power limitation circuit which is intended to execute the functions described above. In such a case, there is no transmission of a power limitation signal Sₗᵢₘ from the control unit 10 to one or more of the batteries B1-B4; such a power limitation signal Sₗᵢₘ is a signal which remains inside the control unit 10, and is transmitted by the data processing unit itself to the power limitation circuit (or if necessary, to the limiting circuits).

The measurement of the instantaneous power absorbed by the at least one power user 101, 102 and/or of the service power user 510 and in particular of the current absorbed by the at least one power user 101, 102, is carried out by an electronic sensor of known type (and therefore not described in detail). The electronic sensor can be external with respect to the control unit 10 or inside the latter. Clearly, where the electronic sensor is external, this sensor will transmit a control signal of the power instantly absorbed by the at least one power user 101, 102 to the control unit 10.

In a preferred and non-limiting embodiment, the control unit 10 is configured to force the activation of the fan for cooling the batteries, even independently of reaching or exceeding said temperature threshold t_{TH}.

More in particular, the control unit 10 is configured and specifically intended to transmit an activation signal to at least one fan for cooling the plurality of batteries B1-B4 when the electrical power P(t) instantly absorbed by the at least one power user 101, 102 and/or the service power user 510, reaches a predefined power value requiring an active cooling. In a non-limiting embodiment, the predefined power value requiring an active cooling is for example substantially equal to ⅔ of the first maximum power value and preferably substantially equal to said first maximum power value.

### Battery Charging Circuits

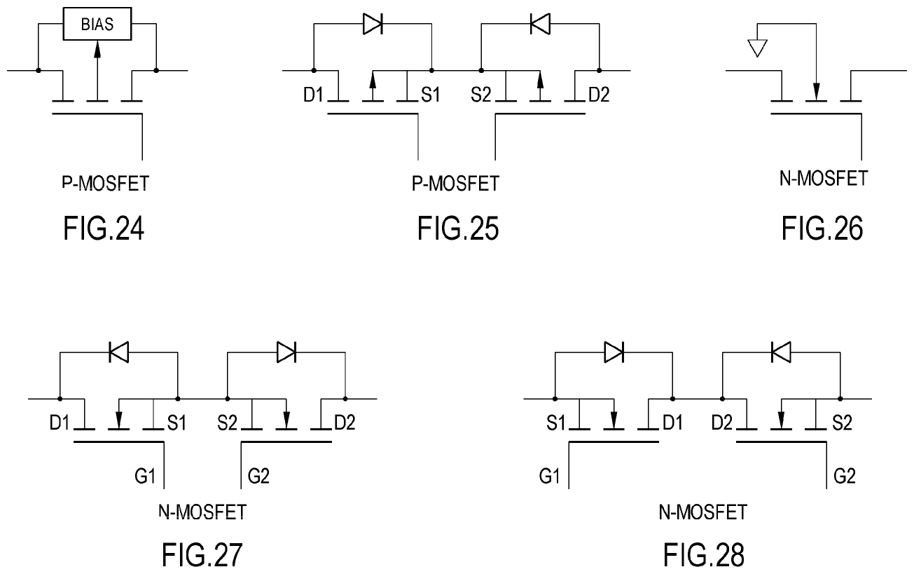

FIG. 24 schematically illustrates a charging circuit of a plurality of batteries, for the sake of simplicity of a first and a second battery B1, B2. As described above, the batteries are connected in parallel with respect to the power supply. A plurality of BPS (Bidirectional Power Switch) modules 40, one for each branch, are arranged in series to the respective battery. In an embodiment, each BPS module makes said switch 44.

FIG. 25 schematically illustrates a power supply circuit of a power user 101, 102 and/or the service power user 510, in which a plurality of batteries, for the sake of simplicity a first and a second battery B1, B2, powers said user.

Also in this power supply configuration, due to the specific physical connection, the plurality of BPS modules 40 is arranged so that, for each power supply branch, there is a BPS module 40 connected in series to the respective battery.

Each BPS module 40 makes an active-type switch which can support a bidirectional current flow when in the closed configuration and a bidirectional current interruption when in the open configuration.

In a preferred but non-limiting embodiment, each BPS module 40 comprises at least one transistor, in particular an FET (field-effect transistor). FIGS. 24, 25, 26, 27, 28 illustrate possible circuit configurations of a BPS module 40 which allow to obtain:
when the BPS module 40 is in an open configuration, an interruption of the bidirectional current flow, to and from the respective battery, regardless of the voltage value at the terminals of the BPS module 40; and
when the BPS module 40 is in a closed configuration, a bidirectional current flow, to and from the respective battery, with voltage at the terminals of the BPS module 40 which is ideally zero.

In particular, FIG. 24 illustrates a circuit configuration with a P-type MOSFET, in which there is a biasing module which allows a correct bias on the source or drain in accordance with the polarity of the voltage. FIG. 25 illustrates a back-to-back type circuit configuration with two P-type MOSFETs. FIG. 26 illustrates a circuit configuration with an N-type MOSFET. FIG. 27 illustrates a back-to-back type circuit configuration with two N-type MOSFETs with a common source configuration. Two diodes, one for each MOSFET, are positioned between the source and the drain, with anodes connected to the respective source, and with the two sources directly connected. A similar technical functionality can be obtained by employing a back-to-back type circuit configuration with two N-type MOSFETs connected in common drain configuration (FIG. 28).

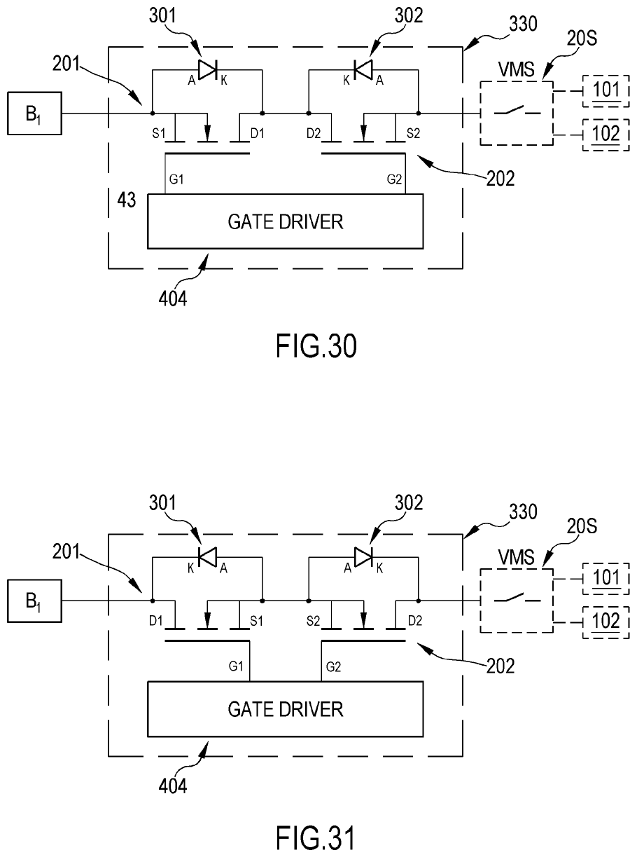

FIGS. 30 and 31 illustrate two particular configurations of a solid-state supply switch circuit 20s′. The supply switch circuit 20s′ which makes a unidirectional power switch, i.e., a power switch capable of allowing the transit of an electric current in only one direction, which in particular is the direction to the at least one power user 101, 102 and/or the service power user 510.

As a switch, the supply switch circuit 20s′ has:
a closed configuration, which allows the passage of current from the batteries B1-B4 to the at least one power user, and
an open configuration, which prevents the passage of current from the batteries B1-B4 to the at least one power user.

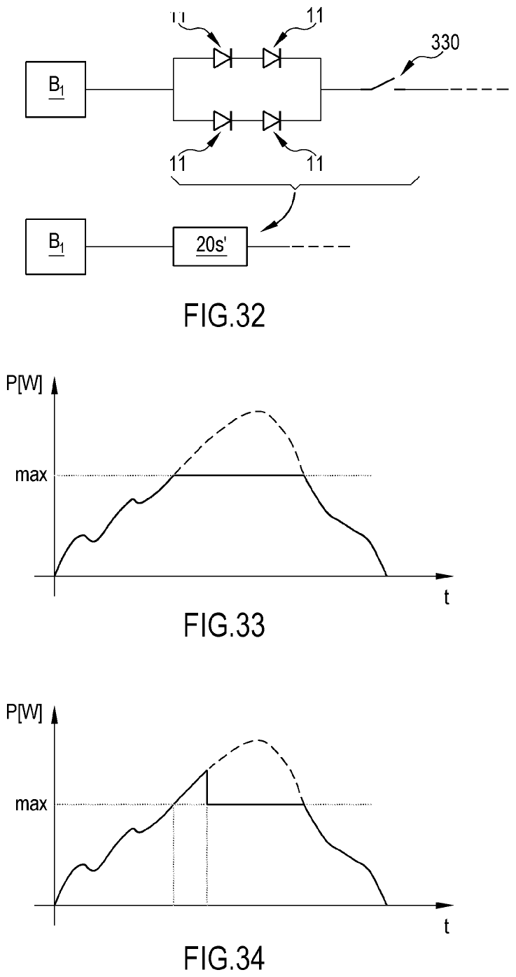

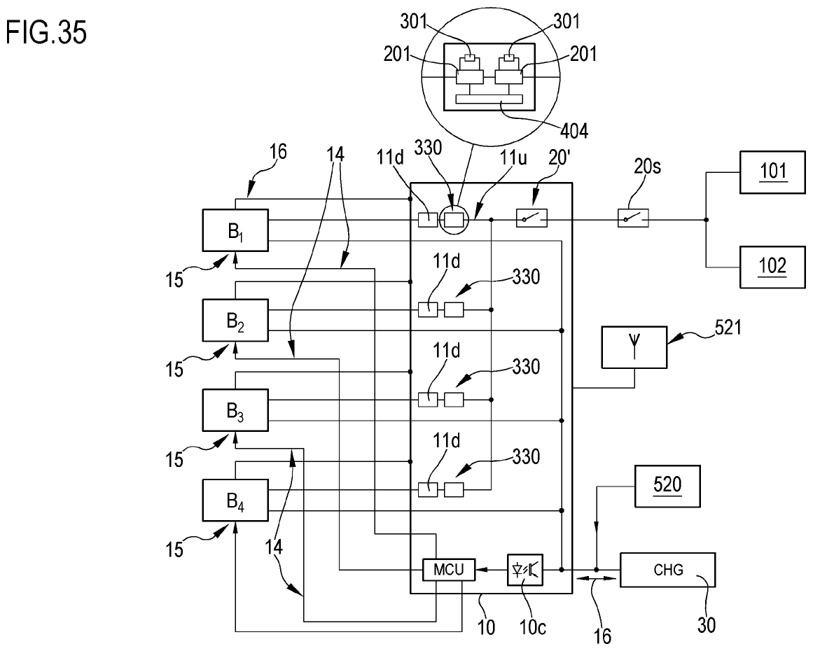

In a preferred but non-limiting embodiment, the supply switch circuit 20s′ is arranged substantially at each of the batteries B1-B4. However, this configuration is not intended to be limiting; in fact, it is possible to have at least one further configuration in which the supply switch circuit 20s′ is arranged outside the battery. Such a configuration is schematically depicted in FIG. 32. FIG. 32 illustrates a principle diagram according to which a plurality of diodes 11 arranged on two branches in which, for each branch, there are two diodes 11 in series and in which the plurality of branches is arranged in series with a switch, the overall assembly formed by the plurality of diodes 11 and the switch, is made by the supply switch circuit 20s′.

The unidirectionality allowed to the current flow is such that, in principle, the supply switch circuit 20s′ comprises a controllable switch in opening and closing and an ideal diode placed in series, to the controllable switch. For example, it can be considered that the ideal diode is placed upstream of the controllable switch, so as to have its anode directly connected to the respective battery.

The supply switch circuit 20s′ is in particular made with a plurality of MOSFETs in back-to-back configuration with controlled piloting; FIGS. 30 and 31 illustrate two non-limiting embodiments which employ N-MOSFETs in back-to-back configuration.

In detail in FIG. 30 a first embodiment is illustrated in which a first N-MOSFET and a second N-MOSFET are connected to each other in the following manner.

Proceeding from the battery to the at least one power user 101, 102, there is a first N-MOSFET 201 whose source terminal S1 is directly connected to the battery. The first N-MOSFET 201 has a drain terminal D1 which is connected to a drain terminal D2 of a second N-MOSFET 202 placed in series with the previous one.

Between the source terminal and the drain terminal of the first N-MOSFET 201 there is a first diode 301 whose anode is connected to the source terminal S1 of the first N-MOSFET 201 and whose cathode is connected to the drain terminal D1 of the first N-MOSFET 201 (and due to the direct connection between the drain terminal D1 of the first N-MOSFET 201 with the drain terminal of the second N-MOSFET 202, the cathode is also connected to the drain terminal D2 of the second N-MOSFET 202).

The second N-MOSFET 202 comprises a source terminal S2, and between the drain terminal D2 and the source terminal S2 of the second N-MOSFET 202 there is a second diode 302, the anode of which is connected to the source terminal S2 and the cathode of which is connected to the drain terminal D2 of the second N-MOSFET 202.

The assembly formed by the first diode 301 in parallel to the source and drain terminals S1, D1 of the first N-MOSFET makes the ideal diode. The assembly formed by the second diode 302 in parallel to the source and drain terminals S2, D2 of the second N-MOSFET makes the controlled switch.

The gate terminal G1 of the first N-MOSFET 201 and the gate terminal G2 of the second N-MOSFET 202 are directly connected to a respective terminal of a gate piloting circuit 404, the purpose of which is to bias the gate terminal G1 of the first N-MOSFET 201 and/or of the second N-MOSFET 202 so as to determine, upon the receipt of a predetermined control signal, the opening or the closing of the channel of the second N-MOSFET 202 so as to determine the simulation of an ideal open or closed switch, and so as to determine, upon receipt of the aforesaid predetermined control signal, the opening or the closing of the channel of the first N-MOSFET 201 so as to determine the behaviour thereof as an ideal diode.

In detail in FIG. 31 a second embodiment is illustrated in which a first N-MOSFET and a second N-MOSFET are connected to each other in the following manner.

Proceeding from the battery to the at least one power user 101, 102, there is a first N-MOSFET 201 whose drain terminal D1 is directly connected to the battery. The first N-MOSFET 201 has a source terminal S1 which is connected to a source terminal S2 of a second N-MOSFET 202 placed in series with the previous one.

Between the source terminal and the drain terminal of the first N-MOSFET 201 there is a first diode 301 whose anode is connected to the source terminal S1 of the first N-MOSFET 201 and whose cathode is connected to the drain terminal D1 of the first N-MOSFET 201. Due to the direct connection between the source terminal S1 of the first N-MOSFET 201 and the source terminal S2 of the second N-MOSFET 202, the anode is also connected to the source terminal S2 of the second N-MOSFET 202.

The second N-MOSFET 202 comprises a source terminal S2, and between the drain terminal D2 and the source terminal S2 of the second N-MOSFET 202 there is a second diode 302, the anode of which is connected to the source terminal S2 and the cathode of which is connected to the drain terminal D2 of the second N-MOSFET 202.

The assembly formed by the first diode 301 in parallel to the source and drain terminals S1, D1 of the first N-MOSFET makes the ideal diode. The assembly formed by the second diode 302 in parallel to the source and drain terminals S2, D2 of the second N-MOSFET makes the controlled switch.

The gate terminal G1 of the first N-MOSFET 201 and the gate terminal G2 of the second N-MOSFET 202 are directly connected to a respective terminal of a gate piloting circuit 404, the purpose of which is to bias the gate terminal G1 of the first N-MOSFET 201 and/or of the second N-MOSFET 202 so as to determine, upon the receipt of a predetermined control signal, the opening or the closing of the channel of the second N-MOSFET 202 so as to determine the simulation of an ideal open or closed switch, and so as to determine, upon receipt of the aforesaid predetermined control signal, the opening or the closing of the channel of the first N-MOSFET 201 so as to determine the behaviour thereof as an ideal diode.

In principle, the first N-MOSFET 201 and the second N-MOSFET 202 could be exchanged with each other, so that the second N-MOSFET 202 has the source terminal S2 directly connected to the battery, and so that the first N-MOSFET 201 is placed downstream (in the direction of the electrical power transmitted to the at least one power user 101, 102 and/or a service power user 510) with respect to the second N-MOSFET 202. However, the configuration illustrated in FIGS. 30 and 31, in which the first N-MOSFET 201 is placed upstream of the second N-MOSFET 202 is the one which ensures greater operating efficiency.

It is also clear that although two embodiments wherein a first N-MOSFET 201 and a second N-MOSFET 202 are present have been described in the present detailed description, in principle such N-MOSFETs can be replaced by any type of JFET, coupled with diodes, capable of obtaining the same technical functionality.

In a preferred, but non-limiting embodiment, the first N-MOSFET 201 and the second N-MOSFET 202, and the first and the second diode 301, 302, are integrated together in a single device or electronic board.

FIGS. 30 and 31 respectively illustrate a first and a second non-limiting embodiment wherein the supply switch circuit 20s′ is positioned upstream with respect to the control unit 10, resulting in particular interposed between the cells 43 of the battery and the control unit 10. In an alternative embodiment, such a supply switch circuit 20s′ is positioned downstream with respect to the control unit 10.

It is noted that although in the appended figures the first and the second diode 301, 302 and the MOSFETs are depicted as separate components, in reality they are integrated in a single chip.

The advantages of using the supply switch circuit 20s′ in the form disclosed herein are evident in the light of the foregoing description. It prevents the recirculation of current from a more charged battery to a less charged battery. The use of the second N-MOSFET 201 advantageously allows to disconnect the discharge of the single battery, allowing an extreme flexibility in the implementation of diagnostic logics and use of the batteries for the power supply of the at least one power user 101, 102 and/or for the power supply of at least one service power user 510. Furthermore, the supply switch circuit 20s′ improves the energy efficiency with respect to the use of a traditional diode in series with a switch. Better energy efficiency means lower losses due to the Joule effect, therefore less heating of the electronics, and less voltage drop. Given a predefined capacity of one or more cells 43, and more generally of one or more batteries, the increase in energy efficiency given by the supply switch circuit 20s′ advantageously allows a greater amount of electrical energy to be made available to the at least one power user 101, 102 and/or of the at least one service power user 510. Moreover, at the same power absorbed by the at least one power user 101, 102, and/or the service power user 510, the average autonomy time made possible by the power supplied by the plurality of batteries B1-B4 is increased.

The control unit 10 is also responsible for controlling the gate piloting circuit 404, and is therefore operatively connected with the latter.

In light of the above description, therefore, it is clear that all the functions previously described, and in particular and without limitation at least one of the functions of selecting the battery to be charged, to then power the at least one power user 101, 102 and/or at least on service power user 510 by means of a plurality of batteries, the function of limiting the power delivered, the function of managing the charging by means of an algorithm which prioritises the priority power user 102 with respect to the secondary power user 201, and the function which allows what is known as the “hot swap” of the batteries can be implemented in association with the presence of said supply switch circuit 20s′.

### Housing of the Electronic Control Board of the Batteries

The devices composing the control unit 10 are at least partly interconnected to each other by means of a PCB serving as a support for such devices. The devices and the PCB form an electronic control board for the batteries of the power supply device 500.

The electronic board is housed inside a casing which is fixed inside the special compartment V3 of the power supply device 500 and which has at least one passage opening for the wiring which allows such an electronic board to be powered and electrically connected to the batteries.

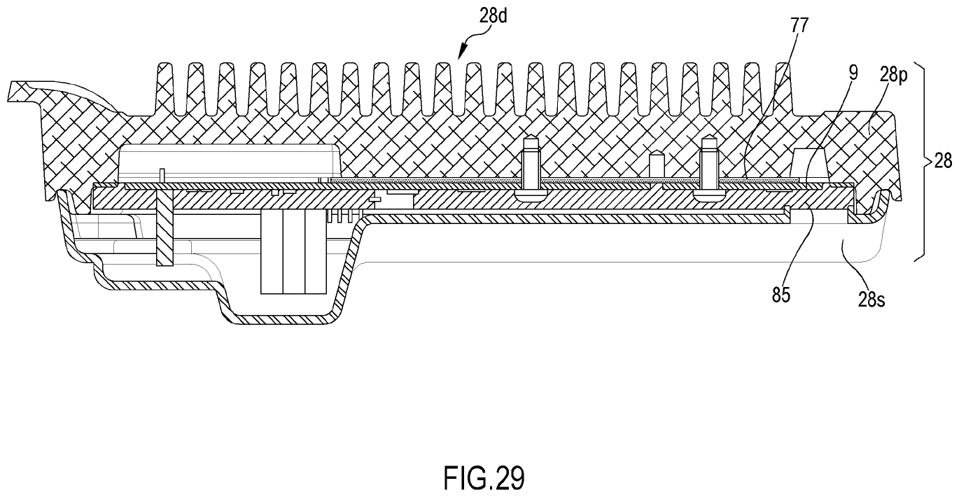

The housing of the electronic board according to the present invention (as depicted in the section of FIG. 29) allows an optimal dissipation of the heat generated by the devices of the control unit 10 (for example, and not limitedly, by the MOSFETs or by the diodes), thus preventing overheating phenomena of the electronic board.

The casing of the electronic board is at least partially made of electrically conductive material. In the example referred to in FIG. 29, the casing 28 housing the electronic board 9 comprises a first half-shell 28P in thermally conductive material (preferably in aluminium) and a second half-shell 28S in thermally insulating material (preferably in moulded plastic), the first half-shell 28P and the second half-shell 28S being connected to each other by means of screws which ensure the separability between the half-shells, in particular so as to perform technical assistance operations.

In an embodiment, a finned thermal heatsink 28D is integrated (or more in general operatively coupled) to the first half-shell 28P. The finned thermal heatsink 28D illustrated in FIG. 29 is integral with the first half-shell 28P, but could alternatively be screwed onto the first half-shell. The first half-shell 28P, and in particular the finned thermal heatsink 28D, is configured and specifically intended to disperse the heat developed by the electronic board 9.

Advantageously, the heat generated by the electronic board 9 is transferred by conduction to the first half-shell 28P. To this end, the electronic board 9 is screwed directly to the first half-shell 28P, so as to minimise the distance between the electronic board 9 and the first half-shell 28P. Furthermore, in the gap which in any case exists between the electronic board 9 and the first half-shell 28P (also for electrical safety reasons) a layer 77 in conductive material is arranged. For example, such a layer 77 can be obtained by a thermally conductive silicone sheet (having a conductivity greater than 2 W/mK). Alternatively to the sheet material, it can be envisaged that the thermally conductive material is affixed to the electronic board 9 in the form of film, paint, glue or foam.

The heat is thus dissipated by the first half-shell 28P by convection. To this end, the first half-shell 28P has a geometry aimed at increasing the surface extension thereof. In the example of FIG. 29, a plurality of cooling fins 8 protrude from the outer surface of the first half-shell 28P, the fins 8 being advantageously obtained in a single piece with the first half-shell 28P.

Preferably, but not limitedly, in the gap between the electronic board 9 and the second half-shell 28S, a material is housed which is intended to isolate the electronic board 9 from moisture or sprays of water. In an embodiment, said material comprises a silicone layer 85. The presence of a layer intended to isolate from moisture or sprays is particularly advantageous in view of the particular environment, also external, wherein the power supply device 500 can be found to operate.

In the light of the above, it can be seen that the heat generated by the devices forming the control unit 10 is efficiently dissipated, through a path which conducts such heat by transmission from the electronic board 8, through the layer 77 in conductive material, to the outer surface of the first half-shell 28P, in particular to the fins 8, where it is finally removed by convection.

It should be noted that the configuration of the casing 28 described herein has in itself inventive contents, independent (albeit synergistic) with respect to the inventive contents related to the configuration of the control unit 10.

### Identification of the Batteries

In an embodiment, the control unit 10 is configured to identify the batteries B1-B4 when installed on-board the power supply device 500. In particular, the control unit 10 is configured to uniquely identify each of the batteries B1-B4, so that it is electronically possible to distinguish the batteries from each other.

If the control unit 10 electronically identifies that one or more of the batteries of the plurality of batteries B1-B4 installed on board the power supply device 500 is discharged or malfunctioning, for example because it does not hold the supplied charge or has an abnormal overheating, the control unit 10 is configured to specifically store which battery among the plurality of said batteries B1-B4 is the one which is discharged or malfunctioning. By virtue of this technical feature, it is possible to electronically identify which battery needs to be removed or replaced or charged, and therefore which are the remaining batteries which can effectively contribute to supplying the power to the at least one power user 101, 102 or to the electric machine of the auxiliary power user 510.

In a preferred, but not limiting, embodiment, in particular when the power supply device is provided with a wireless communication interface, the control unit can be configured to transmit, as a control datum of the operation of the power supply device 500 and to the remote electronic device, a data identifier which, among the batteries installed on board the power supply device 500, is the one actually discharged and/or malfunctioning. A non-limiting example of such a datum can be: “battery B1 discharged”. It should be noted that such an identification datum can in particular comprise not only the identification of the battery but also an associated residual charge value, for example qualitative (e.g., on a multi-notch graphic scale) or quantitative (e.g., 34%, or 1500 mAh) and/or a residual voltage value (e.g., 5V). The transmission can occur upon the request of the remote electronic device or automatically based on one or more pre-set parameters on the control unit 10, in particular according to previously described threshold voltage values.

### Brief Summary of the Advantages

The advantages of the power supply device 500 of the method and of the control unit disclosed above are clear; they allow to obtain a charge and a discharge of batteries for powering users in a particularly efficient manner, and in a safe manner. They allow a separate charging of a plurality of batteries and a substantially common discharging thereof without the need for circuit reconfigurations by an operator. The batteries which fail during the operating life are automatically excluded from the circuit, and this optimises the safety of operation of the power supply device 500 on which the batteries are installed.

The method and the control unit 10 described herein allow to efficiently and safely manage the use of batteries of different type, and contribute to reducing the risk of power overload if batteries of different type and/or with different electrical power delivery capacities are used.

A power supply device 500 controlled by the method or control unit 10 advantageously described herein has greater safety of use in the event that the residual charge and/or the electrical power deliverable by the batteries is limited.

In the latter case, a particular embodiment of the method and of the control unit 10 allow a rapid and immediate restoration or lifting of the residual charge and/or of the electrical power available to the at least one power user 101, 102, by virtue of the presence of the technical “hot swap” feature.

The power supply device 500 also allows to extend the useful life of the batteries, as well as to increase the thermal efficiency thereof.

The power supply device 500 has modular features, and is silent and does not emit harmful gases in use.

The power supply device 500 can be used in humid environments.

Furthermore, the power supply device 500 disclosed herein can be a flexible tool for powering one or more accessories 512, 513, 514 in a safe, efficient, and sufficiently powerful manner. Advantageously, such accessories do not require electrical power. Such accessories can be stored in different locations with respect to the power supply device 500. Such accessories can be purchased at different times with respect to when a user purchases the power supply device 500. The accessories 512, 513, 514, as they are substantially free of electrical parts, can be easily washed.

The invention is not limited to the embodiments depicted in the appended drawings; for this reason, when present, reference numerals or signs indicated in the claims are intended to be provided for the sole purpose of increasing the intelligibility thereof; such reference numerals or signs are not to be understood in a limiting manner.

It is finally evident that additions, modifications or variations can be applied to that which forms the object of the present invention, which are obvious to a person skilled in the art, without departing from the scope of protection provided by the appended claims.

1. Device for powering and/or storing energy, said device being configured to be transportable and to electrically power at least one power user, said device comprising:
a casing configured to contain a plurality of batteries in at least one predefined position,
a charging arrangement intended to allow a charging of said plurality of batteries, and
a control unit configured to control the charging of said plurality of batteries.

2. The device according to claim 1, wherein said charging arrangement comprises at least one charging socket configured to be connected to a power supply mains or at least one energy generator.

3-7. (canceled)

8. The device according to claim 1, wherein the control unit comprises a charging operating configuration and a power supply operating configuration, wherein, in said charging operating configuration, said control unit:
selects a first part of said plurality of batteries,
causes a selective charging, by a power supply of said first part of said plurality of batteries,
selects a further part of said plurality of batteries, and
causes a selective charging, by a power supply of said further part of said plurality of batteries, wherein the charging of said further part of said plurality of batteries is enabled only upon completion of the charging of said first part of said plurality of batteries, and wherein, in said power supply operating configuration, the control unit causes a power supply of the at least one power user, determining, in use, a transfer of electrical energy to said at least one power user simultaneously occurring from said first part of said plurality of batteries and from said further part of said plurality of batteries.

9-13. (canceled)

14. The device according to claim 1, comprising at least one power output, operatively connected, in use, to the plurality of batteries through said control unit, wherein the control unit is configured to control the supply of electrical energy to said at least one power user through said power output, the device further comprising an inverter, operatively connected to said plurality of batteries and connected to said at least one power output, said inverter being configured to generate, in use, on said at least one power output an alternating electrical voltage starting from the direct electrical voltage generated by the plurality of batteries, wherein said inverter is operatively connected to said plurality of batteries by means of said control unit.

15-20. (canceled)

21. The device according to claim 1, wherein the control unit is configured and specifically intended to cause a selection and/or an electronic limitation of said maximum electrical power deliverable by each battery of the plurality of batteries.

22-27. (canceled)

28. The device according to claim 1, comprising a wireless interface module configured to operatively interface with a remote electronic device and to receive and/or transmit, respectively from and/or to said remote electronic device, diagnostic and/or statistical and/or usage and/or control and/or alarm data, wherein said diagnostic and/or statistical and/or usage and/or control and/or alarm data are associated with the operation of the device or of the control unit or of one or more of the batteries of the plurality of batteries, said device further comprising at least one environmental sensor configured and specifically intended to allow one or more environmental parameters to be detected near said device, wherein said at least one environmental sensor is a temperature sensor or a humidity sensor or a solar light or radiation sensor or a barometric pressure sensor, wherein said at least one environmental sensor is operatively connected with the wireless interface module, wherein the usage and/or control and/or alarm data comprise temperature and/or humidity and/or brightness and/or barometric pressure data obtained from said at least one environmental sensor and/or at least one datum of power, energy, residual charge, voltage, current absorbed by one or more of the batteries of the plurality of batteries in said charging operating configuration or in said power supply operating configuration of said device and/or at least one datum of power, energy, residual charge, voltage, current absorbed by one or more of the power users in said charging operating configuration or in said power supply operating configuration of said device, wherein the usage and/or control and/or alarm data comprise at least one temperature datum of one or more of the batteries of the plurality of batteries and/or at least one datum of exclusion and/or lack of one or more of the batteries of the plurality of batteries.

29-45. (canceled)

46. The device according to claim 1, wherein at least one battery of said plurality of batteries comprises at least one supply switch, and a control input operatively connected to said supply switch and externally connected to a control line of the control unit, said supply switch comprising an open configuration wherein it prevents the charging of one or more cells of the respective battery and a closed configuration wherein it enables the charging of one or more cells of the respective battery, wherein each battery of the plurality of batteries comprises a respective supply switch of solid-state type, wherein each battery of said plurality of batteries comprises a containment casing adapted to be transported and/or stored and/or handled by a user, at least one cell positioned within said containment casing, the supply switch being positioned within said containment casing, and wherein each battery of said plurality of batteries comprises a connector, accessible at an exposed portion of said containment casing and configured to be removably connected with a counter-connector arranged within the casing of the device.

47-70. (canceled)

71. A device for powering and/or storing energy, said device being configured to be transportable and to electrically power at least one power user, said device comprising:
a casing configured to contain and/or support at least one battery in at least one predefined position,
a charging arrangement intended to allow a charging of said at least one battery,
a service power user, configured to be powered by said at least one battery, and further configured to provide at least one driving force and/or an electrical energy to at least one accessory removably connectable to said device, and
a connector, arranged substantially at said service power user, configured to retain at least part of said at least one accessory, and to release said at least one accessory.

72-84. (canceled)

85. The device according to claim 71, further comprising a control unit configured to control the charging of said at least one battery and to control the supply of electrical energy to said at least one power user, wherein, in the case of applying a plurality of batteries to said device, said control unit is configured to pilot a sequential charging of said batteries and a parallel discharging of said batteries.

86-92. (canceled)

93. The device according to claim 71, wherein the connector of said device is configured to retain at least part of said at least one accessory by means of a snap- and/or screw- and/or bayonet- and/or translational-type connection.

94-98. (canceled)

99. The device according to 71, wherein the device is configured as a trolley or suitcase and comprises towing and/or dragging means and movement and/or sliding means, wherein said towing and/or dragging means comprise at least one handle of a telescopic and/or extensible type, wherein said movement and/or sliding means comprise a plurality of rollers and/or wheels and/or balls, and wherein said movement and/or sliding means are applied to a portion of said casing opposite the portion of said casing to which said towing and/or dragging means are applied.

100-103. (canceled)

104. The device according to 71, wherein the casing comprises at least one door configured to allow access to a predefined portion inside the casing itself, said door being configured to allow access to said at least one compartment housing, in use, said at least one battery, said door being movable between an open configuration wherein it allows access to said predefined internal portion of the casing and a closed configuration wherein it prevents access to said predefined internal portion of the casing, said closed configuration of the door determining an insulation of said internal portion of the casing, wherein said door, in said open configuration, allows access to said at least one compartment housing, in use, said at least one battery, and wherein said closed configuration of the door determines an insulation of said at least one compartment housing, in use, said at least one battery.

105-111. (canceled)

112. The device according to claim 71, wherein said at least one compartment is configured to allow an introduction or an operative extraction of said at least one battery by means of a substantially linear translation, said at least one compartment comprising at least one guide configured to guide the translation of said at least one battery, said at least one compartment comprising a power supply connector, configured to couple with at least one pair of terminals present on said at least one battery and configured to provide, in use, electrical energy to said at least one service power user.

113-114. (canceled)

115. The device according to claim 71, comprising a wireless interface module configured to operatively interface with a remote electronic device and to receive and/or transmit, respectively from and/or to said remote electronic device, usage and/or control and/or alarm data, wherein said usage and/or control and/or alarm data are associated with the operation of the device or with the operation of the at least one battery or with the operation of one or more of the batteries of the plurality of batteries, wherein said wireless interface module is configured to receive and/or transmit said data in selective mode, respectively to and from a selected number of remote electronic devices and/or to one or more predefined remote electronic devices, and wherein said device is configured to receive, by means of said wireless interface module a command to activate and/or deactivate the electrical energy supply to said service power user.

116-121. (canceled)

122. The device according to 71, comprising a charging module, said charging module being operatively connected to said at least one battery, said charging module being configured to receive, in use, electrical energy from said at least one battery, and being configured to transfer said electrical energy to a tool or to an electronic apparatus, wherein said charging module is configured to transfer said electrical energy to said tool or to said electronic apparatus, when in contact with at least one terminal present on said charging module for tools or when said tool or said electronic apparatus is substantially near said charging module.

123-133. (canceled)

134. The device according to claim 71, comprising at least one electrochemical device capable of directly converting chemical energy into electrical energy, said electrochemical device being configured to provide electrical energy intended to at least partially charge the at least one battery, wherein said at least one electrochemical device is a fuel cell.

135-138. (canceled)

139. The device according to claim 71, comprising at least one photovoltaic cell panel, said photovoltaic cell panel being configured to provide electrical energy intended to at least partially charge the at least one battery, wherein said photovoltaic cell panel is arranged substantially at said casing or is removably connectable to said casing.

140-145. (canceled)

146. The device according to claim 71, comprising an identification module, configured to receive data of at least one feature of said accessory, said identification module being positioned substantially at said service power user, said identification module being configured to transmit at least part of said data of said at least one feature of said accessory to a control unit of said device, said control unit being configured to electronically detect any malfunctions of said accessory by electronically comparing, current and/or electrical voltage absorption data from said at least one service power user, with said data of at least one feature of said accessory.

147. (canceled)

148. A kit comprising:
a device configured to be transportable,
at least one battery, and
an accessory removably connectable to said device,
wherein said device comprises:
a casing configured to contain and/or support said at least one battery in at least one predefined position,
a charging arrangement intended to allow a charging of said at least one battery,
a service power user, configured to be powered by said at least one battery, and further configured to provide at least one driving force to said accessory, and
a connector, arranged substantially at said service power user, configured to retain at least part of said at least one accessory, and to release said accessory,
wherein said accessory is configured to be removably coupled to the service power user of said device and configured to receive driving force.

149-152. (canceled)

153. The kit according to claim 148, wherein said accessory comprises a casing and a connector adapted to be removably coupled to the connector of said device, said accessory comprising a counter-shaft configured to be, in use, placed in rotation by the shaft of the service power user when the connector of the accessory is connected on said connector of said device, and wherein said accessory comprises a fan or an aspirator or a vacuum cleaner or a refrigerating machine or a heating device or an actuator configured to drill or an actuator configured to cut or an actuator configured to sand or an actuator configured to bend or an actuator configured to lift or an actuator configured to generate electrical current or an actuator configured to compress a fluid or a scintillator.

154-517. (canceled)
